(19) United States
(12) Patent Application Publication
(10) Pub. No.: US 2010/0280758 A1
(43) Pub. Date: Nov. 4, 2010

(54) METHOD AND AN APPARATUS FOR DETERMINING NUCLEOTIDE SEQUENCE, AND A COMPUTER PROGRAM PRODUCT TO BE EXECUTED BY THE APPARATUS

(75) Inventor: Sadato Hongo, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Minato-ku (JP)

(21) Appl. No.: 12/299,190

(22) PCT Filed: Sep. 26, 2008
(86) PCT No.: PCT/JP2008/002679

§ 371 Date: Oct. 31, 2008

(30) Foreign Application Priority Data
Dec. 19, 2007 (JP) 2007-327737

(51) Int. Cl. G06F 19/00

(52) U.S. Cl. 702/19

(57) ABSTRACT

A method for determining nucleotide sequence encompasses (a) injecting a solution containing a sample nucleic acid into a chip cartridge, (b) detecting first detection, second detection, and control signals through electrodes on the chip cartridge, (c) calculating a first difference between a mean value of the control signals and a mean value of the first detection signals, and dividing the first difference by the mean value of the control signals to define X, (c) calculating a second difference between the mean value of the control signals and a mean value of the second detection signals, and dividing the second difference by the mean value of the control signals to define Y, (d) calculating an angle between a positive X-axis and a vector from origin to a point (X, Y), and (d) comparing the angle with angle judgment criteria so as to identify a genotype of the sample nucleic acid.

### TECHNICAL FIELD

The present invention relates to a nucleotide sequence determination method for determining nucleotide sequence (base sequence), of a nucleic acid, an apparatus (nucleotide sequence determination system) facilitating the nucleotide sequence determination method, and a computer program product for automatically controlling the apparatus so as to automatically analyze measured signals so that the nucleotide sequence of the nucleic acid can be determined.

### BACKGROUND ART

The human genome is composed of approximately three billion genetic codes (bases). The “human genome project” currently underway is set to solve the entire genetic code (nucleotide sequence). In this course of events, the fact that many differences exist in the genetic codes (nucleotide sequence) of individual human beings is becoming clear. Differences in human genome nucleotide sequences (polymorphism) are classified into SNP where one base is substituted with another base, variable number of tandem repeats (VNTR or microsatellite polymorphism) due to an absence or intercalation of between one and several thousand bases, and the like, though currently, SNP is particularly drawing attention among such types of polymorphism. SNP is the difference in one base out of the DNA nucleotide sequence, and is the smallest unit of a human characteristic trait including the ability to handle alcohol and whether drugs have a strong effect. Among the three billion base pairs in the humane genome, it is suggested that approximately three million (a ratio of one per 500 to 1000 base pairs) to ten million SNP bases exist, which bring about differences in people (physical traits) such as the inability to make particular proteins or the production of proteins difference from other people, racial differences and the like. With respect to research into genetic individual differences in human beings, it is said the analysis of SNP and investigation of the susceptibility to diseases and the response to medicines will make made-to-order medical treatment possible where medicine suited to the patient and with few side effects to the patient is administered, and research into SNP analysis is progressing. For plants, it is possible to identify the mechanism of resistance to disease and pests that the plant has conventionally and enhance those functions.

A reason that can be given why attention is focused on SNP is the increase in interest in the relationship between disease and SNP because analysis of a variety of SNPs is possible through improvements in analysis techniques. The object of that research spans a wide range including disease-related genes, analysis of the individual differences in drug metabolism, and chronic diseases. The relationship with SNP has been explained for some cases of drug metabolization and lipid metabolism. Future clarifications are expected to gradually develop regarding these issues and SNP.

Molecular biological engineering such as SNP analysis includes a vast number of manipulations on an extremely large number of samples. Those manipulations are frequently complex and time-consuming, and they generally require a high level of precision. For many techniques, the absence of sensitivity, specificity, or reproducibility limits their application.

For example, problems that accompany sensitivity and specificity have thus far limited practical applications of nucleic acid hybridization. “Hybridization” refers to the formation of nucleic acids and the formation of nucleic acid hybrid molecules, and is used as a method for studying the primary structure of nucleic acids, that is the homology of nucleotide sequences, and for detecting nucleic acids having homologous nucleotide sequences. Hydrogen bonds can be formed between base pairs having complementarity whose nucleic acids are in a strand, that is, between adenine (A) and thymine (T) as well as between guanine (G) and cytosine (C), and the characteristic of nucleic acids to form two double helix strands is usendingeneral, nucleic acid hybridization analysis includes the detection of an extremely small number of specific target nucleic acids (DNA or RNA) from a large volume of non-target nucleic acids using a probe. To maintain a high specificity, hybridization under the strictest of conditions is carried out, ordinarily achieved by variously combining temperature, salts, detergents, solvents, chaotropic agents, and denaturants. The majority of samples, and particularly DNA in human genome DNA samples is associated with extreme complexity. When a sample is made from an extensive number of sequences closely resembling a specific target sequence, a large number of partial hybridizations occur with the non-target sequences even with the most unique of probes. There are also cases where undesirable hybridization kinetics are involved between probe DNA and its specific target (sample DNA). Even under the most favorable of conditions, the majority of hybridization reactions are carried out with relatively low concentrations of probe DNA and target molecules (sample DNA). In addition, probe DNA often competes with complementary sequence for sample DNA. There is also the problem that high-level non-specific background signals are generated because probe DNA has an affinity for almost any substance. Either individually or in combination, these problems thus cause a loss of sensitivity and specificity in nucleic acid hybridization.

Based on such circumstances, the present inventors have already proposed a method (refer to Patent Citation 1) for carrying out significant difference determinations, for example, using a t-test on the size of signals in order to make a determination (of homo-type or hetero-type of bases) of the SNP or a method (refer to Patent Citation 2) for analyzing a ratio between the magnitudes of the respective signals. In the method described in the Patent Citation 1, a hetero-type determination is not made unless the two types of signal values match nearly completely. However, in an actual measurement, such conditions are impossible. Also, the method described in the Patent Citation 2 proposes the method for carrying out the analysis in accordance with the ratio between the signals, in order to solve the problems. However, there is a problem that the judgment precision is poor when one signal increment is “negative” or very small.

In this manner, genotyping algorithms for determining the nucleotide sequence of nucleic acids exist in earlier technology, but there are problems with the accuracy of determination.

### Patent Citation 1: JP-A 2004-125777 (KOKAI)

### Patent Citation 2: JP-A 2006-258702 (KOKAI)

### DISCLOSURE OF INVENTION

In view of these situations, it is an object of the present invention to provide a method and an apparatus for determining nucleotide sequence (base sequence), and a computer program product to be executed by the apparatus for determining the nucleotide sequence, which have a high accuracy in determination of the nucleotide sequence, establishing an immediate determination in practice.

An aspect of the present invention inheres in a method for determining nucleotide sequence comprising (a) injecting a solution containing a sample nucleic acid into a chip cartridge, which is provided with a plurality of first detecting electrodes to which first probe nucleic acids are respectively immobilized, a plurality of second detecting electrodes to which second probe nucleic acids having different nucleotide sequences from the first probe nucleic acids are respectively immobilized, and a plurality of control electrodes to which control nucleic acids having different nucleotide sequences from the first and second probe nucleic acids are respectively immobilized, (b) detecting first detection signals through the first detecting electrodes, second detection signals through the second detecting electrodes, and control signals through the control electrodes, respectively, (c) calculating a value of a first difference obtained by subtracting a mean value of the control signals from a mean value of the first detection signals, and dividing the value of the first difference by the mean value of the control signals so as to define a value of X-coordinate, (d) calculating a value of a second difference obtained by subtracting a mean value of the control signals from a mean value of the second detection signals, and dividing the value of the second difference by the mean value of the control signals so as to define a value of Y-coordinate, (e) calculating an angle between a positive X-axis and a vector from origin to a point which is defined by the X-coordinate and the Y-coordinate, and (f) comparing the angle with angle judgment criteria so as to identify a genotype of the sample nucleic acid, in accordance with a magnitude relation between the angle and the angle judgment standard.

Another aspect of the present invention inheres in an apparatus for determining nucleotide sequence comprising (a) a chip cartridge having a plurality of first detecting electrodes to which first probe nucleic acids are respectively immobilized, a plurality of second detecting electrodes to which second probe nucleic acids having different nucleotide sequences from the first probe nucleic acids are respectively immobilized, and a plurality of control electrodes to which control nucleic acids having different nucleotide sequences from the first and second probe nucleic acids are respectively immobilized, (b) a detecting system configured to detect first detection signals through the first detecting electrodes, second detection signals through the second detecting electrodes, and control signals through the control electrodes, respectively, (c) a fluid transport system configured to inject a reagent solution into the chip cartridge, and (d) a computer comprising a typing module configured to calculate a value of a first difference obtained by subtracting a mean value of the control signals from a mean value of the first detection signals, and to divide the value of the first difference by the mean value of the control signals so as to define a value of X-coordinate, to calculate a value of a second difference obtained by subtracting a mean value of the control signals from a mean value of the second detection signals, and dividing the value of second difference by the mean value of the control signals so as to define a value of Y-coordinate, to calculate an angle between a positive X-axis and a vector from origin to a point which is defined by the X-coordinate and the Y-coordinate, and to compare the angle with angle judgment criteria so as to identify a genotype of the sample nucleic acid.

Still another aspect of the present invention inheres in a computer program product to be executed by an apparatus for determining nucleotide sequence, the computer program product comprising (a) instructions configured to inject a reagent solution into a chip cartridge, which is provided with a plurality of first detecting electrodes to which first probe nucleic acids are respectively immobilized, a plurality of second detecting electrodes to which second probe nucleic acids having different nucleotide sequences from the first probe nucleic acids are respectively immobilized, and a plurality of control electrodes to which control nucleic acids having different nucleotide sequences from the first and second probe nucleic acids are respectively immobilized, (b) instructions configured to detect first detection signals through the first detecting electrodes, second detection signals through the second detecting electrodes, and control signals through the control electrodes, respectively, (c) instructions configured to calculate a value of a first difference obtained by subtracting a mean value of the control signals from a mean value of the first detection signals, and to divide the value of the first difference by the mean value of the control signals so as to define a value of X-coordinate, (d) instructions configured to calculate a value of a second difference obtained by subtracting a mean value of the control signals from a mean value of the second detection signals, and to divide the value of the second difference by the mean value of the control signals so as to define a value of Y-coordinate, (e) instructions configured to calculate an angle between a positive X-axis and a vector from origin to a point which is defined by the X-coordinate and the Y-coordinate, and (f) instructions configured to compare the angle with angle judgment criteria so as to identify a genotype of the sample nucleic acid.

### BRIEF DESCRIPTION OF THE DRAWINGS

FIG. 1 is a schematic diagram explaining one example of a detecting system that implements the nucleotide sequence determination system according to an embodiment.

FIG. 2 is a representational plan view explaining the configuration of a detection chip that implements part of the detecting system in FIG. 1.

FIG. 3A is a schematic plot depicting three strands of probe DNAs, endowed with nucleotide sequence GACTC . . . , immobilized to a top surface of an SNP=“G” detecting electrode.

FIG. 3B is a schematic plot depicting three strands of probe DNA, endowed with nucleotide sequence GAATC . . . , immobilized to a top surface of an SNP=“T” detecting electrode.

FIG. 3C is a schematic plot depicting three strands of probe DNA (negative control DNA), endowed with nucleotide sequence CAGTG . . . , immobilized to a top surface of a control electrode.

FIG. 4 is a bird's eye view of a representational configuration explaining one example of the configuration of a chip cartridge used in the nucleotide sequence determination system according to the embodiment.

FIG. 5 is an inverted bird's eye view of the configuration of the chip cartridge in FIG. 4.

FIG. 6 is a schematic plot depicting the overall configuration of a valve unit of a fluid transport system that implements the nucleotide sequence determination system according to the embodiment.

FIG. 7 is a logical block diagram explaining an example of the nucleotide sequence determination system according to the embodiment.

FIG. 8 is a logical block diagram explaining an example of the organization of the computer system that implements the nucleotide sequence determination system according to the embodiment.

FIG. 9A is a schematic plot depicting two strands of probe DNAs, immobilized to the top surface of the SNP=“G” detecting electrode, and two strands of sample DNA with SNP=“G”, which are paired into double-strands with the probe DNAs, because the nucleotide sequences match perfectly with the probe DNAs.

FIG. 9B is a schematic plot depicting two strands of probe DNA immobilized to the top surface of the SNP=“T” detecting electrode, showing that sample DNA with SNP=“G” is unable to form a double-strand with probe DNAs.

FIG. 9C is a schematic plot depicting two strands of probe DNA (negative control DNA) immobilized to the top surface of the control electrode, showing that sample DNA with SNP=“G” is unable to form a double-strand with probe DNAs.

FIG. 10A is a schematic plot depicting two strands of probe DNAs, immobilized to the top surface of the SNP=“T” detecting electrode, showing that sample DNA with SNP=“T” is unable to form a double-strand with probe DNAs.

FIG. 10B is a schematic plot depicting two strands of probe DNA, immobilized to the top surface of the SNP=“T” detecting electrode, and two strands of sample DNA with SNP=“T”, which are paired into double-strands with the probe DNAs, because the nucleotide sequences match perfectly with the probe DNAs.

FIG. 10C is a schematic plot depicting two strands of probe DNA (negative control DNA) immobilized to the top surface of the control electrode, showing that sample DNA with SNP=“T” is unable to form a double-strand with probe DNAs.

FIG. 11A is a schematic plot depicting two strands of probe DNAs, immobilized to the top surface of the SNP=“G/T” detecting electrode, and two strands of heterogeneous sample DNA with SNP=“G/T”, which are paired into double-strands with the probe DNAs, because the nucleotide sequences match with the probe DNAs.

FIG. 11B is a schematic plot depicting two strands of probe DNA, immobilized to the top surface of the SNP=“G/T” detecting electrode, and two strands of heterogeneous sample DNA with SNP=“G/T”, which are paired into double-strands with the probe DNAs, because the nucleotide sequences match with the probe DNAs.

FIG. 11C is a schematic plot depicting two strands of probe DNA (negative control DNA) immobilized to the top surface of the control electrode, showing that heterogeneous sample DNA with SNP=“G/T” is unable to form a double-strand with probe DNAs.

FIG. 12A is a schematic plot depicting two strands of probe DNAs, immobilized to the top surface of the SNP1 detecting electrode (SNP=“G” detecting electrode), and two strands of sample DNA with SNP=“G”, which are paired into double-strands with the probe DNAs, and intercalation agents have intercalated into the double-strand.

FIG. 12B is a schematic plot depicting two strands of probe DNA immobilized to the top surface of the SNP2 detecting electrode (SNP=“T” detecting electrode), showing that the intercalation agent can not be intercalated, because the sample DNA with SNP=“G” is unable to form a double-strand with probe DNAs.

FIG. 12C is a schematic plot depicting two strands of probe DNA (negative control DNA) immobilized to the top surface of the control electrode, showing that the intercalation agent can not be intercalated, because the sample DNA with SNP=“G” is unable to form a double-strand with probe DNAs.

FIG. 13 shows three electro-chemical current vs. voltage characteristics corresponding to FIG. 12A, 12B and 12C.

FIG. 14 is a flow chart explaining the overall process of the nucleotide sequence determination method according to the embodiment.

FIG. 15 is a schematic plot explaining the smoothing based on the simple moving average method.

FIG. 16 is a flow chart explaining an example of the method for determining normality or abnormality in current wave forms (current-voltage characteristics) based upon the slopes of the tail lines (characteristic baselines) of the current wave forms, using the electro-chemical currents measured through a plurality of electrodes, respectively.

FIG. 17 shows two examples of the electro-chemical currents measured in the chip cartridge, wherein the slope of the tail line (characteristic baseline) of the current-voltage characteristic labeled with data 2 is larger than the slope of the tail line of the current-voltage characteristic labeled with data 1.

FIG. 18A is a flow chart explaining an example of the method for obtaining the net peak value (peak current value) of the detected signal from the wave forms of electro-chemical currents (current-voltage characteristics) measured through each electrode respectively, subtracting the background current in each case, in the nucleotide sequence determination method according to the embodiment.

FIG. 18B is a flow chart to explain the procedure in the method for obtaining the net peak value (peak current value) of the detected signal from the wave forms of electro-chemical current (current-voltage characteristic) measured through each electrode respectively, following to the procedure shown in the flow chart in FIG. 18A.

FIG. 19 is a schematic plot explaining the method for obtaining a “zero-cross” point by using the differential curve (di/dv) of the electro-chemical current, the “zero-cross” point serves as a point where the background current is subtracted from the wave form of electro-chemical current (current-voltage characteristic) measured through each electrode respectively, in the nucleotide sequence determination method according to the embodiment.

FIG. 20 is a schematic plot explaining the method for approximating a straight line to the curved line of the current-voltage characteristic, the approximated straight line is employed in a sequence of calculation steps, which subtracts the background current from the wave forms of electro-chemical current (current-voltage characteristic) measured through each electrode respectively, in the nucleotide sequence determination method according to the embodiment.

FIG. 21 is an enlarged view of FIG. 20.

FIG. 22 is a schematic plot explaining the method for obtaining a net detected signal from a peak current, subtracting the corresponding background current from the peak current at the zero-cross voltage, in the nucleotide sequence determination method according to the embodiment.

FIG. 23A is a bar graph showing peak current values measured through a plurality of control electrodes, a plurality of SNP2 detecting electrodes (SNP=“T” detecting electrodes) and a plurality of SNP1 detecting electrodes (SNP=“G” detecting electrodes) respectively, in which the peak current values measured through SNP2 detecting electrodes manifest sparse abnormality.

FIG. 23B is a bar graph showing peak current values measured through a plurality of control electrodes, a plurality of SNP2 detecting electrodes (SNP=“T” detecting electrodes) and a plurality of SNP1 detecting electrodes (SNP=“G” detecting electrodes) respectively, in which the peak current values measured through SNP2 detecting electrodes manifest scattered abnormality.

FIG. 23C is a bar graph comparing the positive control current values, the negative control current values with an upper limit setting parameter NCUL and a negative control lower limit setting parameter NCLL.

FIG. 24 is a flow chart explaining an example of the method for judging whether or not the subject data groups is normal so that abnormal data group can be eliminated, determining the sparse abnormality and the scattering abnormality, in the nucleotide sequence determination method according to the embodiment.

FIG. 25A is a flow chart explaining the method for deciding whether to proceed to a first algorithm determining whether a certain nucleic acid is present or not, or to proceed to a second algorithm determining wild type, hetero type or the mutant type, in the nucleotide sequence determination method according to the embodiment.

FIG. 25B is a flow chart explaining an example of the first algorithm for determining whether or not a certain nucleic acid is present, in the nucleotide sequence determination method according to the embodiment.

FIG. 25C is a flowchart describing an example of the second algorithm for determining whether the SNP type is wild type, hetero type or the mutant type, in the nucleotide sequence determination method, according to the embodiment.

FIG. 26 is a view describing definitions of the vector length “R” and the angle “A” in a polar coordinate (R, A) system.

FIG. 27 is a view showing an example in which the nucleotide sequence determination method according to the embodiment is applied to serum amyloid A (SAA) 1 gene polymorphisms.

FIG. 28 is a conceptual image view showing various angle judgment criteria employed for identifying wild homo type, hetero type and the mutant homo type, in the nucleotide sequence determination method, according to the embodiment.

FIG. 29A is a flowchart showing an example of the algorism for validity-of-test judgement, in the nucleotide sequence determination method, according to the embodiment.

FIG. 29B is a flowchart showing a sequence of process-steps after when the mean-value of the negative control current values lie in the outside of a range between the negative control lower limit setting parameter NCLL and the negative control upper limit setting parameter NCUL in the step S403, in the nucleotide sequence determination method according to the embodiment. p FIG. 30 is a conceptual image view showing an upper signal increment criterion SL (−) for “−(less than detection sensitivity)” judgment and a lower signal increment criterion SL (+) for “+” judgment for judging the presence or absence of the nucleic acid, in the nucleotide sequence determination method, according to the embodiment.

### BEST MODE FOR CARRYING OUT THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified. Generally and as it is conventional in the representation of nucleotide sequence determination systems, it will be appreciated that the various drawings are not drawn to scale from one figure to another nor inside a given figure, and in particular that the layer thicknesses are arbitrarily drawn for facilitating the reading of the drawings.

In the following description specific details are set forth, such as specific materials, processes and equipment in order to provide a thorough understanding of the present invention. It will be apparent, however, to one skilled in the art that the present invention may be practiced without these specific details. In other instances, well-known manufacturing materials, processes and equipment are not set forth in detail in order not to unnecessarily obscure the present invention. Prepositions, such as “on”, “over”, “under”, “beneath”, and “normal” are defined with respect to a planar surface of the substrate, regardless of the orientation in which the substrate is actually held. A layer is on another layer even if there are intervening layers.

(Nucleotide Sequence Determination System)

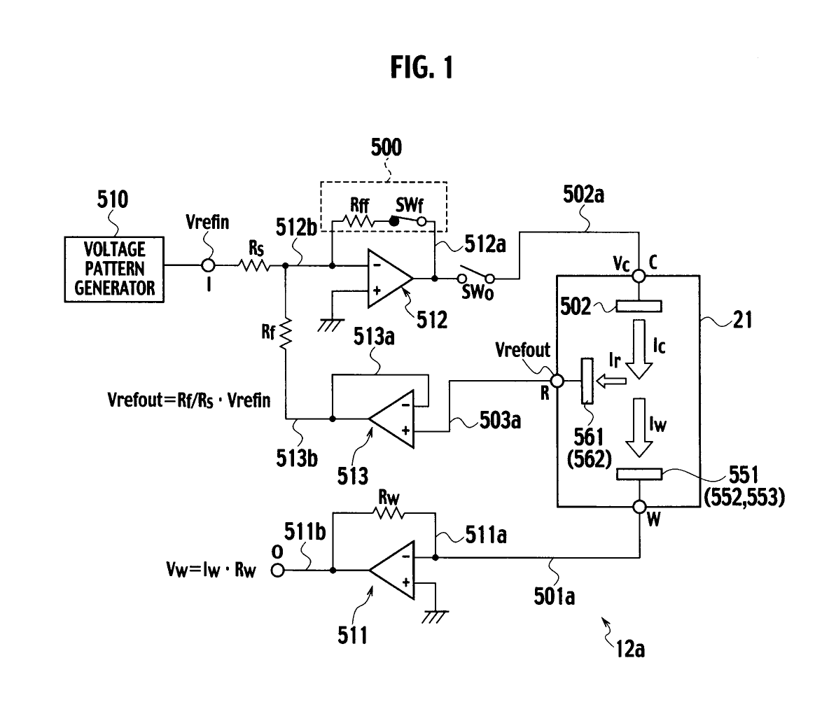

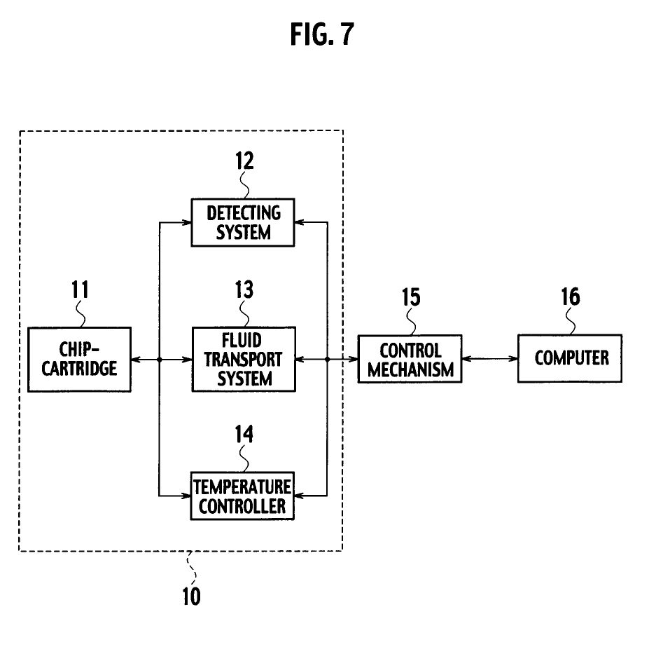

As shown in FIG. 7, a nucleotide sequence determination system according to an embodiment encompasses a chip cartridge 11, a detecting system 12 electrically connected to this chip cartridge 11, a fluid transport system 13 physically connected through an interface portion to a flow channel provided in the chip cartridge 11, and a temperature controller 14 for controlling the temperature of the chip cartridge 11, and the like. As shown in FIG. 1, the detecting system 12 of FIG. 7 is the potensiostat of a triple-electrode architecture, which feeds back (negatively returns) the voltages of reference electrodes 561, 562 to the input of an opposite electrode 502 and consequently applies a desirable voltage to the solution, irrespectively of the dispersion in various conditions such as the electrode and solution inside a cell, and this is connected to terminals C, R and W of the detection chip 21. A detection chip 21 of FIG. 7 is contained in the chip cartridge 11 of FIG. 7.

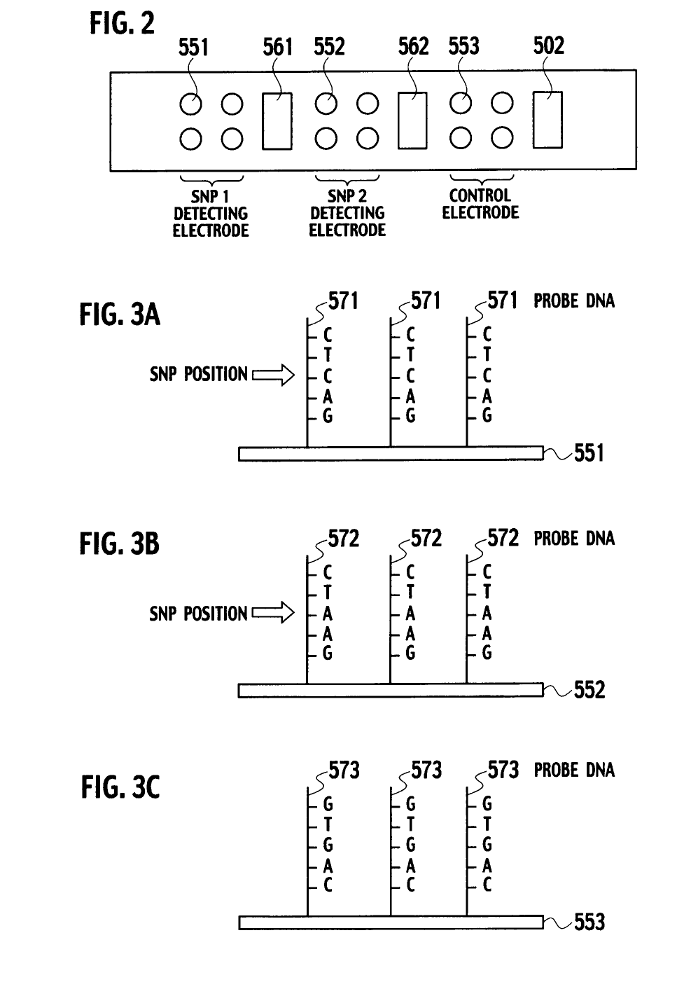

As shown in FIG. 2, the detection chip 21 uses the electrode unit in which active electrodes 551 serving as an SNP1 detecting electrode; active electrodes 552 serving as an SNP2 detecting electrode; active electrodes 553 serving as a control electrode, the reference electrodes 561, 562 for those active electrodes 551, 552 and 553 and the opposite electrode 502 are arranged on the detection chip. That is, the detecting system 12 changes the voltage of the opposite electrode 502 so that the voltages of the reference electrodes 561, 562 for the active electrodes 551, 552 and 553 are set to certain predetermined characteristics and electrochemically measures the current resulting from the electrochemical reaction of intercalation agent (hereafter, referred to as “the electrochemical current”).

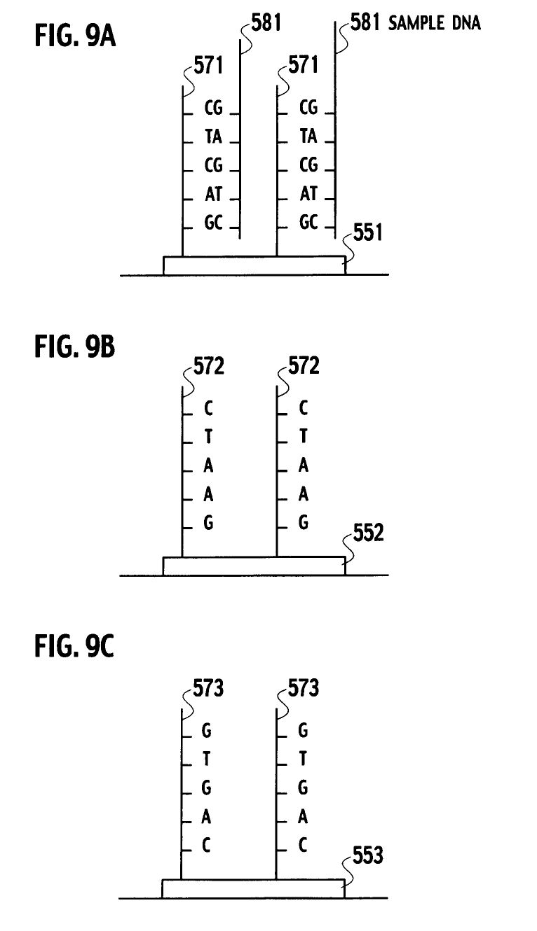

In the nucleotide sequence determination method according to the embodiment of the present invention, first probe DNA (first probe nucleic acid) 571 and second probe DNA (second probe nucleic acid) 572 having complementary nucleotide sequences with target nucleotide sequences (sample DNAs) 581, 582, and 583 as shown in FIGS. 9A, 9B, 9C, 10A, 10B, 10C, 11A, 11B, and 11C, are firstly fixed to the active electrodes 551 and 552, respectively, the sample DNAs 581, 582, and 583 are the targets of nucleotide sequence determination. In further detail, as shown in FIG. 3A, the active electrode 551 is an electrode configured to immobilize the probe DNA (first probe nucleic acid) 571 having a nucleotide sequence GACTC . . . , which is complementary to the nucleotide sequence of sample nucleic acid (sample DNA) 581, serving as the target nucleotide sequence, having the nucleotide sequence CTGAG . . . shown in FIG. 9A. By the way, in this embodiment, although the sample DNA and the probe DNA are noted, different nucleic acids, such as PNA, RNA and the like, other than DNA may be used as the sample or probe nucleic acid. In FIG. 3A, the base at the SNP position is assigned at C, the third from the bottom, so the detecting electrode is prescribed as a SNP=“G” detecting electrode.

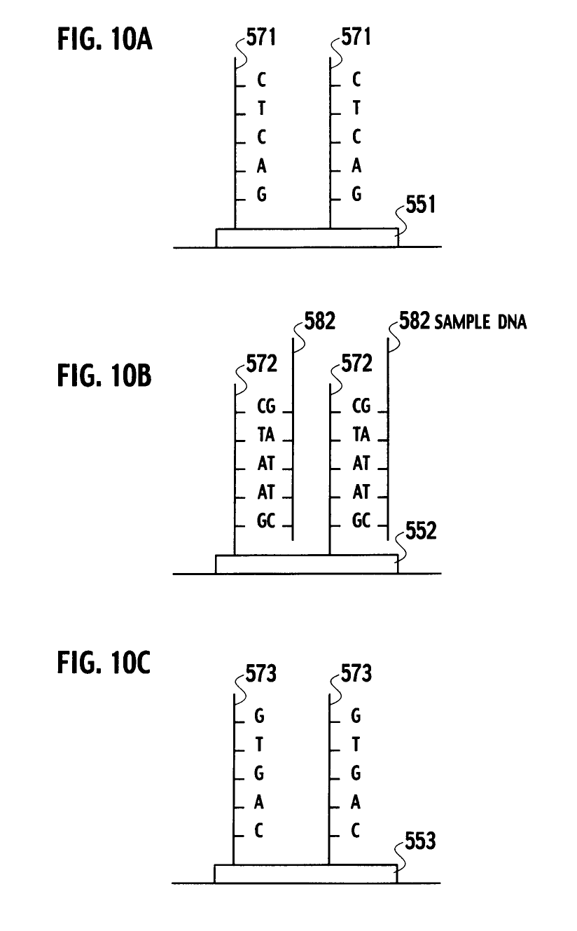

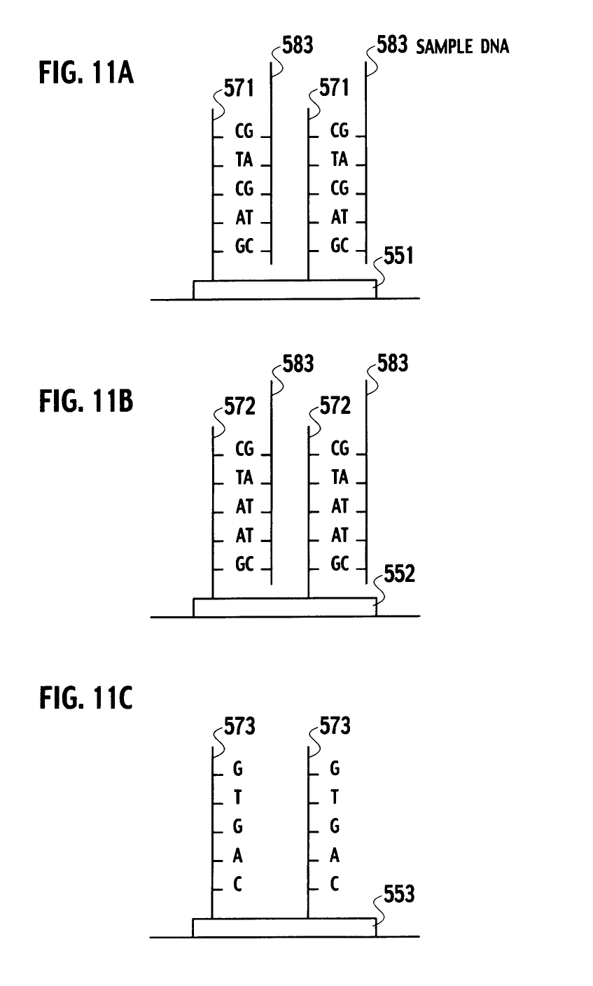

Also, as shown in FIG. 3B, the active electrode 552 is the electrode to which the second probe DNA 572 having a nucleotide sequence GAATC . . . complementary to the nucleotide sequence of sample nucleic acid (sample DNA) 582, serving as the target nucleotide sequence, having a nucleotide sequence CTTAG . . . shown in FIG. 10 is immobilized. Also, FIG. 3B shows an SNP=“T” detecting electrode in which the base at the SNP position is assigned at “A”, the third from the bottom.

On the other hand, as shown in FIG. 3C, the active electrode 553 is the control electrode to which a control nucleic acid (control DNA) 573 having the nucleotide sequence CAGTG . . . that does not have any complementary relation to the sample nucleotide sequences (sample DNAs) 581, 582 serving as the target nucleotide sequences is immobilized. Those active electrodes 551, 552 and 553 serve as the electrode for detecting the reaction current inside the cell. By the way, the types of the probe DNAs 571, 572 and control DNA 573 immobilized to the active electrodes 551, 552 and 553 are designed to detect the sample DNAs having the nucleotide sequences different from each other, although the types of the probe DNAs and control DNAs immobilized to the respective active electrodes are not required to be single.

Between the opposite electrode 502 and the active electrode 551, between the opposite electrode 502 and the active electrode 552, and between the opposite electrode 502 and the active electrode 553, a predetermined voltage is applied respectively so as to establish corresponding current in the cell. Through the reference electrodes 561 and 562, a voltage between the reference electrode 561 and the active electrode 551, a voltage between the reference electrode 561 and the active electrode 552, a voltage between the reference electrode 562 and the active electrode 552, and a voltage between the reference electrode 562 and the active electrode 553 are feed back to the opposite electrode 502 so as to regulate each of the voltages between the reference electrodes 561, 562 and the active electrodes 551, 552, and 553 in predetermined voltage characteristics; the voltage is thereby controlled by the opposite electrode 502, so the electrochemical current can be detected with a high level of precision without being affected by various detection conditions in the cell.

As shown in FIG. 1, the detecting system 12 in the nucleotide sequence determination system according to the embodiment of the present invention encompasses a voltage pattern generator 510 configured to generate a voltage pattern for detecting current flowing between electrodes. The voltage pattern generator 510 is connected to an inverting input terminal of an inverting amplifier (OPc) 512 configured to regulate the reference voltage of the reference electrodes 561 and 562 through an input wire 512b. The voltage pattern generator 510 encompasses a DA converter so that the voltage pattern generator 510 can convert digital signal, transmitted from the control mechanism 15 shown in FIG. 7, to analog signal, while generating a voltage pattern. A resister R, is connected to the input wire 512b between a terminal “I” and the inverting input terminal of the inverting amplifier (OPc) 512. The non-inverting input terminal of the inverting amplifier 512 is grounded, and an output wire 502a is connected to between the output terminal of the inverting amplifier 512 and a terminal “C”. The input wire 512b at the inverting input terminal side and the output wire 502a at the output terminal side of the inverting amplifier 512 are connected by a bypass feedback wire 512a branching from the input wire 512b and the output wire 502a, respectively. A protection circuit 500 encompassing a feedback resistor R_{ff} and a switch SW_{f} is provided at the feedback wire 512a. The output wire 502a is connected to a terminal “C” of the detection chip 21. The terminal “C” is connected to the opposite electrode 502 on the detection chip 21. If a plurality of opposite electrodes 502 are provided, a plurality of terminals C corresponding to the plurality of opposite electrodes 502 are provided in parallel. Voltage can thereby be applied simultaneously to the plurality of opposite electrodes 502 with one voltage pattern. The output wire 502a is provided with a switch SWₒ for turning the voltage to the terminal(s) “C” on and off.

The protection circuit 500 shunting between the input and output of the inverting amplifier 512 forms a circuit such as to prevent excess voltage from being applied to the opposite electrode 502. An excess of voltage is therefore not applied during measurement and the solution is not electrically dissolved, making stable measurement possible without an effect on the electrochemical detection of the desired intercalation agent.

The terminal “R” of the detection chip 21 is connected to a non-inverting input terminal of a voltage follower amplifier (OPᵣ) 513 by an input wire 503a. Between the inverting input terminal and the output terminal of the voltage follower amplifier 513 is shorted by a wire 513a. An output wire 513b is connected between the output terminal of the voltage follower amplifier 513 and a node on the input wire 512b, through a resister R_{f} provided on the output wire 513b, the node on the input wire 512b is assigned to a connection point between the output side of resistor Rs and the input wire 512b, which serves as a branching point of the feedback wire 512a and the input wire 512b. That is, the resister R_{f} is provided between the output terminal of the voltage follower amplifier 513 and the node on the input wire 512b. Based on the output of inverse amplified voltage supplied from the inverse amplifier 512, by delivering a feedback voltage transferred from the reference electrodes 561 and 562 to the inverting input terminal of the inverting amplifier 512, the voltage pattern generated by the voltage pattern generation current 510 is feedback-controlled so as to provide a controlled voltage to the opposite electrode 502.

The terminal “W” of the detection chip 21 is connected to the inverting input terminal of a transimpedance amplifier (OP_{w}) 511 by an input wire 501a. The non-inverting input terminal of the transimpedance amplifier 511 is grounded. From an output wire 511b connected to the output terminal of the transimpedance amplifier 511, a feedback wire 511a is branched so as to connect with the input wire 501a. A feedback resistor RW is provided at the feedback wire 511a so as to shunt between the input side and the output side of the transimpedance amplifier (OP_{w}) 511. If the voltage of a terminal “O” on the output side of the transimpedance amplifier 511 is V_{w} and the current is I_{w}, then:

V_{w}=I_{w}·R_{w} (1)

The electrochemical signals obtained from the terminal “O” are transferred to the regulation mechanism shown in FIG. 7. Because a plurality of sets of active electrodes (551, 552, and 553) are provided, a plurality of terminals “W” and terminals “O” are provided corresponding to the number of the sets of active electrodes (551, 552, and 553). Respective outputs from the plurality of terminals “O” are sequentially switched by a signal switching portion described below, and electrochemical signals from the plurality of sets of active electrodes (551, 552, and 553) can be obtained nearly simultaneously as a set of digital values through AD conversion. A common Circuit such as the transimpedance amplifier 511, to be provided between the terminal “W” and the terminal “O”, may share the plurality of sets of active electrodes (551, 552, and 553). In such a common sharing configuration, a signal switching portion may be provided to switch each of the plurality of wires from the plurality of terminals “W” to a single input wire 501a.

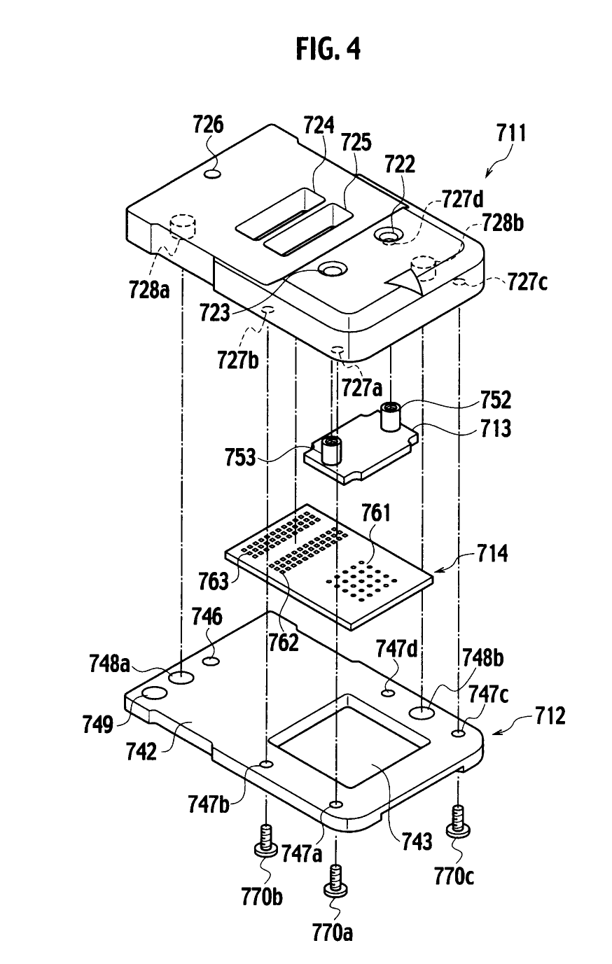

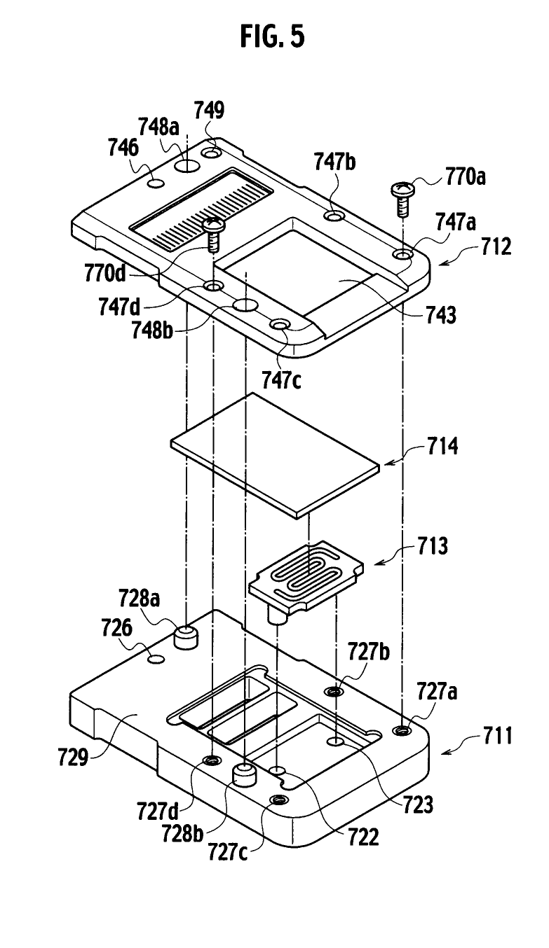

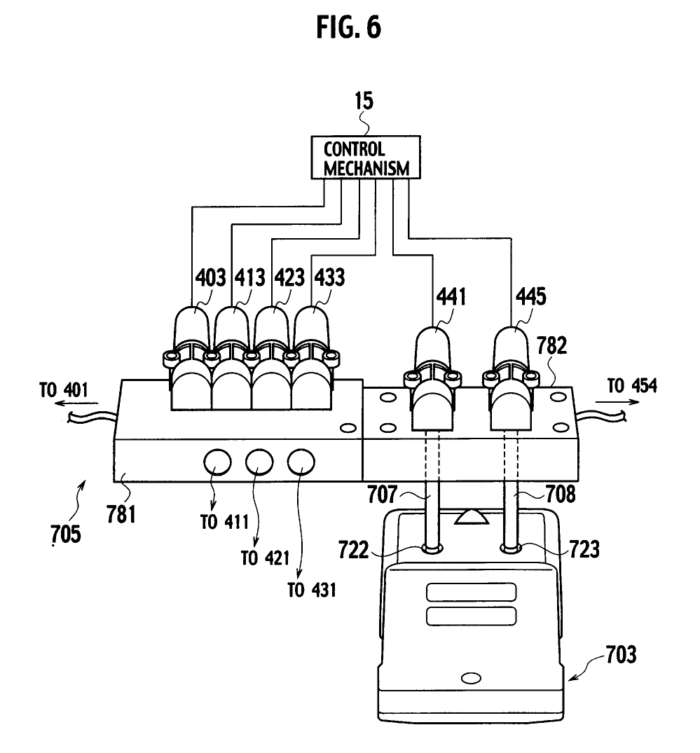

As shown in FIGS. 4 and 5, the chip cartridge 11 implementing the nucleotide sequence determination system of FIG. 7 encompasses a cassette made from a cassette top lid 711, a cassette bottom lid 712, packing-plate 713 (a seal member), and a substrate 714. The inner surfaces of the cassette top lid 711 and the cassette bottom lid 712 are in opposition and are fixed such as to surround the packing-plate 713 and the substrate 714. From the outer surface to the inner surface of the cassette top lid 711, a couple of nozzle intercalation holes 722 and 723 are passing through, the cross-sectional view of the nozzle intercalation holes 722 and 723 cut perpendicular to the direction along the outer surface to the inner surface of the cassette top lid 711 is roughly circular geometry. The inner diameter of the circular nozzle intercalation holes 722 and 723 is set to about 3.2 mm, for example, slightly larger than the outer diameter of nozzles 707 and 708 of FIG. 6 and the inlet and outlet ports 752 and 753. As shown in FIG. 4, from the outer surface to the inner surface of the cassette top lid 711, a couple of windows, or electrical connector ports 724 and 725 are passing through, the cross-sectional view of the electrical connector ports 724 and 725 cut perpendicular to the direction along the outer surface to the inner surface of the cassette top lid 711 is roughly rectangular geometry. The electrical connector ports 724 and 725 are windows, which are configured to be inserted with electrical connectors described below. Also, a seal detection hole 726 is formed to pass from the outer surface through to the inner surface. The seal detection hole 726 is used for detecting the presence of a seal. In further detail, a solution (sample) is injected into the cassette (detection chip) 21 with a seal affixed from the surface of the seal detection hole 726 on the outer surface of the cassette (detection chip) 21 to the surface of the electrical connector ports 724 and 725, and after injection of the solution (sample) into the cassette (detection chip) 21, the seal is removed, and detection is made for presence of the seal. By injecting the solution (sample) into the cassette (detection chip) 21 with the seal affixed, there is no concern that a malfunction will occur such as an electrical short as liquid does not actually enter inside the electrical connector ports 724 or 725 even if the solution (sample) should mistakenly drip onto the electrical connector ports 724 or 725 because they are covered with the seal.

As shown in FIG. 5, a substrate alignment groove with a predetermined depth and a cross-sectional shape nearly identical to the cross-sectional shape of the substrate 714 is provided at the inner surface side of the cassette top lid 711 and is surrounded by the inner surface, the cross-sectional shape corresponds to a cross-section cut perpendicular to the direction along the outer surface to the inner surface of the cassette top lid 711. The substrate alignment groove is formed so as to occupy an area overlapping with the locations where nozzle intercalation holes 722 and 723 as well as the electrical connector ports 724 and 725 are disposed. By inserting the substrate 714 to fit the substrate alignment groove, the substrate 714 can be disposed to match the position of the cassette top lid 711. The substrate alignment groove is formed so that its depth is roughly the same as the thickness of the substrate 714.

As shown in FIG. 5, a packing-plate guiding groove even deeper than the substrate alignment groove is provided so as to overlap with the area of the substrate alignment groove at the inner surface side of the cassette top lid 711, and the perimeter of the packing-plate guiding groove is surrounded by the substrate alignment groove. The lateral area of the packing-plate guiding groove is formed so as to overlap with an area where the nozzle intercalation holes 722 and 723 are located. A packing-plate 713 can be inserted aligned with the packing-plate guiding groove so as to be positioned at the cassette top lid 711. The depth, with regard to the horizontal level of the substrate alignment groove, of the packing-plate guiding groove is selected so as to have approximately the same thickness as the thickness of the packing-plate 713 described below. Accordingly, with regard to the horizontal level of the inner surface of the cassette bottom lid 712, the depth of the packing-plate guiding groove is determined such as to be approximately the same to the sum of the thickness of the packing-plate 713 and the thickness of the substrate 714.

Four screw holes 727a, 727b, 727c, and 727d are provided at the periphery of the inner surface of the cassette top lid 711. The cassette top lid 711 and the cassette bottom lid 712 can be screwed together with these screw holes 727a, 727b, 727c, and 727d. Two cassette positioning holes 728a and 728b are provided at the periphery of the inner surface of the cassette top lid 711. By disposing the cassette (detection chip) 21 in alignment with two positioning pins provided on a slide stage of the nucleotide sequence determination system, the cassette (detection chip) 21 can be positioned and aligned with respect to the slide stage.

A seal detection hole 746 is formed to pass through the outer surface of the cassette bottom lid 712. The seal detection hole 746 of the cassette bottom lid 712 is formed at a position communicating with the seal detection hole 726 of the cassette top lid 711 when the cassette top lid 711 and the cassette bottom lid 712 are closed together. The penetrating seal detection hole 726 is thereby provided from the cassette top lid 711 to the cassette bottom lid 712, so that detection light can be irradiated on the seal detection hole 726 when the cassette top lid 711 and the cassette bottom lid 712 are closed together, and the presence of a seal can thereby be determined.

Four screw holes 747a, 747b, 747c, and 747d are provided at the periphery portion of the outer surface of the cassette lower lid 712. By twisting screws into the corresponding screw holes 727a to 727d provided at the cassette top lid 711, the cassette bottom lid 712 can be fastened to the cassette top lid 711. Two cassette positioning holes 748a and 748b are provided at the periphery of the outer surface of the cassette bottom lid 712. Cassette positioning holes 728a and 728b of the cassette top lid 711 pass through the cassette positioning holes 748a and 748b, respectively. Positioning of the cassette (detection chip) 21 with respect to the slide stage is established, regulated by the two positioning pins provided on the slide stage of the nucleotide sequence determination system and the two positioning holes 728a and 728b of the cassette top lid 711 passing through the cassette positioning holes 748a and 748b of the cassette bottom lid 712. Also, a cassette type identification hole 749 is provided at the cassette bottom lid 712, and the type of the cassette (detection chip) 21 can be identified according to the presence or absence of the cassette type identification hole 749. Type identification can be carried out automatically by judging whether the lowering of the cassette type identification pin (illustration omitted) is conducted or not. The state of lowering the cassette type identification pin (illustration omitted) is detected by the control mechanism 15.

Even if a cassette (detection chip) 21 is used without a cassette type identification hole 749 provided, it is possible to measure in a similar manner with only the difference in the types of the cassettes (detection chips) 21 being identified. Alternatively, a design may be made where the difference in the types of the cassettes (detection chips) 21 is displayed on a display unit (illustration omitted) by the control mechanism 15, a warning given off, and the process stopped before measurement. As another alternative, an anchored anchoring pin may be used for the cassette type identification pin (illustration omitted) and an architecture can be designed such that a cassette (detection chip) 21 not provided with the cassette type identification hole 749 cannot be attached, thereby preventing the wrong cassette (detection chip) 21 from being set in place.

As shown in FIG. 4, the packing-plate 713 encompasses a roughly rectangular plate portion with a prescribed thickness formed with the four corners notched, and a cylindrical inlet port 752 and outlet port 753 positioned near either of the long ends on the main surface of the plate portion and provided near the center of the short ends. Openings are provided at the ends of the inlet port 752 and the outlet port 753. A flow channel is provided along a direction perpendicular to the main surface of the plate portion at the axial centers of the inlet port 752 and the outlet port 753. As shown in FIG. 5, the backside of the plate portion has a meandering groove formed in a twisting form from the allocation position of the inlet port 752 to the allocation position of the outlet port 753. The meandering groove implements a meandering flow channel. The meandering groove is formed such as to proceed back and forth a plurality of times, and each of the twist points of the meandering groove has a predetermined curvature ratio so as to suppress accumulation of solution or air that would occur when sharp corners or the like are provided for the twist points.

As shown in FIG. 4, a plurality of electrode units 761, a plurality of pads 762 and a plurality of pads 763 are arranged at the main surface of the substrate 714. As shown in FIG. 2, each of the electrode units 761 is implemented by a three-electrode configuration made from a combination of the opposite electrode 502, the active electrodes 551, 552, and 553, and the reference electrodes 561 and 562. First probe DNAs (first probe nucleic acids) 571, second probe DNAs (second probe nucleic acids) 572 and control DNAs (control nucleic acids) 573 are immobilized to the active electrodes 551, 552, and 553 in each of the plurality of electrode units 761. Each of the plurality of electrode units 761 is connected to the corresponding pad 762 and the corresponding pad 763 by wires not illustrated. A case is exemplified in FIG. 4 where the plurality of electrode units 761 for immobilizing a plurality of probe DNAs, the plurality of pads 762 and the plurality of pads 763 are formed on the same surface of the substrate 714, though if the plurality of pads 762 and the plurality of pads 763 are formed on the opposite side of the substrate 714 than that on which the plurality of electrode units 761 are formed, a valve unit 705 may be disposed above the cassette (detection chip) 21, and a probe unit 710 may be disposed below the cassette (detection chip) 21. In that case, the valve unit 705 and the probe unit 710 need not necessarily be integrated as one unit.

The arrangement for the plurality of electrode units 761 is made to match the allocation route of the meandering flow channel at the position of the packing-plate. When the packing-plate 713 and the substrate 714 are anchored in a state fastened by the cassette top lid 711 and the cassette bottom lid 712, a meandering flow channel is thereby formed by the meandering groove and the surface of the substrate 714, and the plurality of electrode units 761 protrude to the surface of the meandering flow channel. In further detail, a meandering gap is provided by the meandering groove against to the plurality of electrode units 761, and the meandering flow channel is formed by the meandering gap. In this state, a seal is provided between the packing-plate 713 and the substrate 714.

(a) Firstly, the packing-plate 713 is fit together in the packing-plate guiding groove by intercalation so as to match the packing-plate guiding groove of the inner surface of the cassette top lid 711 and such that the inlet port 752 and the outlet port 753 accommodate the nozzle intercalation holes 722 and 723.

(b) Then, the substrate 714 is provided at the substrate alignment groove such that one of the main surfaces of the substrate 714, that is, the surface on which the plurality of electrode units 761 and the plurality of pads 762 and the plurality of pads 763 are arranged, faces to the cassette top lid 711.

(c) Then, the cassette bottom lid 712 is placed on the cassette top lid 711 such that the inner surface 742 of the cassette bottom lid 712 faces the cassette top lid 711 and that the positions of the screw holes 747a to 747d and the screw holes 727a to 727d are aligned.

(d) The screws 770a to 770d are then inserted by twisting them into the screw holes 747a to 747d and the screw holes 727a to 727d. The cassette top lid 711 and the cassette bottom lid 712 are thereby tightened by screws, and the packing-plate 713 and the substrate 714 are fixed between the cassette top lid 711 and the cassette bottom lid 712, thereby completing the cassette (detection chip) 21. In this completed state, the meandering flow channel is formed so as to route from the nozzle intercalation hole 722 to the nozzle intercalation hole 723.

In FIGS. 4 and 5, an example is shown where a plurality of screws fasten the cassette top lid 711 and the cassette bottom lid 712, but the invention is not limited the screw-fastening configuration. A locking method may also be used where a concavo-convex member, for example, is mutually adopted so as to tighten the concave member with the convex member.

FIG. 6 shows an entire configuration of a valve unit 705 provided in the fluid transport system 13 so as to implement the nucleotide sequence determination system according to the embodiment of the present invention. In FIG. 6, the configuration of the probe unit is omitted; the probe unit is integrated as one unit with the valve unit 705, and the valve unit and the probe unit are driven simultaneously by a valve-unit-probe-unit-drive mechanism. For example, two electrical connectors are disposed at predetermined intervals at the probe unit encompassing a glass epoxy substrate and the like. A plurality of convex electrodes are arranged at the ends of the electrical connectors in a matrix form with the same arrangement as the pads on the substrate 714, and these convex electrodes are in contact with the plurality of pads 762 and the plurality of pads 763 of the substrate 714 shown in FIG. 4, thereby ensuring electrical connections between the substrate 714 and the probe unit. A plurality of wire are provided in the electrical connectors, electrically connecting the convex electrodes and the control mechanism 15.

The valve-unit-probe-unit-drive mechanism is driven automatically by instructions from the control mechanism 15. The valve-unit-probe-unit-drive mechanism has a vertical drive direction. When the nozzles 707 and 708 and the bunch of electrical connectors 703 are thereby lowered relative to the upper portion of the cassette (detection chip) 21 on the slide stage side, the nozzles 707 and 708 are thereby positioned at the nozzle intercalation holes 722 and 723, and two bunches of electrical connectors 703 are positioned respectively at the electrical connector ports 724 and 725 as shown in FIG. 6. The meandering flow channel inside the cassette (detection chip) 21 and the fluid transport system 13 communicate each other so that liquid solution can be conveyed automatically. Also, the electrical connectors are positioned at the plurality of pads 762 and the plurality of pads 763 of the cassette (detection chip) 21, electrically connecting the plurality of pads 762 and the plurality of pads 763 with the bunch of electrical connectors.

The valve unit 705 embraces a plurality of valve bodies 781 and 782, establishing a linking connection with each other, although a couple of valve bodies 781 and 782 is shown in FIG. 6 so as to simplify the drawing. A two-way electromagnetic valve 403 and three-way electromagnetic valves 413, 423, and 433 are provided at the valve body 781, and three-wavy electromagnetic valves 441 and 445 are provided at the valve body 782. The valve body 781 may be manufactured from polyether-ether-ketone (PEEK™) resin, for example. For a case that the valve body 781 and the valve body 782 are manufactured separately, and polytetrafluoroethylene (PTFE) resin, for example, is used as packing material for the joint portion if the two are joined. Accordingly, the material of the portion of both valve bodies 781 and 782 that comes into contact with solution may be made from PEEK™ or PTFE. A cavity with an approximately constant cross-section is provided in each of the valve bodies 781 and 782. The cavity functions as a pipe to provide a connection between electromagnetic valves described below, the packing-plate 713, and the like. The nozzles 707 and 708 communicate at the cavity provided at the valve body 782. The nozzle 707 and the nozzle 708 may be made from PEEK™ resin.

The three-way electromagnetic valve 413 switches between air and pure water, supplying them to the three-way electromagnetic valve 423 downstream. The three-way electromagnetic valve 423 switches between a buffer solution, the air and the pure water from the three-way electromagnetic valve 413, supplying them to the three-way electromagnetic valve 433 downstream. The three-way electromagnetic valve 433 switches between an intercalation agent, the air and the pure water, and the buffer solution supplied from the three-way electromagnetic valve 423, supplying them to the valve body 782 downstream. The three-way electromagnetic valve 441 switches between supplying air and solution from the valve body 781 to the nozzle 707 and supplying the three-way electromagnetic valve 445 through a bypass pipe. The three-way electromagnetic valve 445 switches between supplying the air and the solution from the three-way electromagnetic valve 441 and sending the solution and the air through the nozzle 708 from the cassette (detection chip) 21.

In order to send the buffer solution into the cassette (detection chip) 21 in the valve unit 705 shown in FIG. 6, the three-way electromagnetic valves 423, 441, and 445 and the liquid sending pump 454 are turned ON. This leads to the buffer solution being drawn up, the buffer solution being switched to the nozzle 707, then drawn from the nozzle 707 to the cassette (detection chip) 21, and from the cassette (detection chip) 21 to the nozzle 708, and discharged through the three-way electromagnetic valve 445. In order to send pure water into the cassette (detection chip) 21, the three-way magnetic valve 413 is turned ON rather than the three-way electromagnetic valve 423. In order to send intercalation agent into the cassette (detection chip) 21, the three-way electro-magnetic valve 433 is turned ON instead of the three-way electromagnetic valve 423. In order to supply air into the cassette (detection chip) 21, the three-way electro-magnetic valve 403 is turned ON, and any of the three-way electromagnetic valve 412, 423, or 433 is turned OFF. The internal volume of the pipe for the cavity portion provided in the valve body 781 of the valve unit 705 is about 100 microlitres, including the volume in the valve. If, unlike the present embodiment, the three-way valves are connected with a tube to implement the same flow, an internal volume of about 500 microlitres is required, though the sample solution volume can be greatly decreased. The internal volume between the valve unit 705 and the cassette (detection chip) 21 is greater than 100 microlitres in the example compared to the present embodiment, but in the present embodiment, a large reduction of 10 microlitres is possible. With such a configuration, after the switch to the sample solution, the volume of the sample solution or the air flowing in the cassette (detection chip) 21 contrary to intentions can be greatly decreased. As a result, fluctuation in reactions and measurements can be decreased, greatly improving the reproducibility of the results.

A solution shaking device not illustrated is provided, so the sample solution can be shaken automatically in the chip cassette. Shaking the sample solution is effective in:

(a) a hybridization process of sample DNA and probe DNA;
(b) a washing process; and
(c) an intercalation agent supply process, and the like.

Shaking the sample DNA in the hybridization process, pointed as item (a), improves the efficiency of hybridization, reducing the time therefore. Shaking buffer fluid in the washing process, pointed as item (b), improves the efficiency of stripping the non-specific adsorption DNA, thereby shortening the washing time. Also, shaking the intercalation agent in the intercalation agent supply process, pointed as item (c), improves the uniformity of intercalation agent concentration and the uniformity of intercalation agent adsorption, improving signal fluctuation and the S/N ratio. The effects of solution shaking can be obtained by applying the automatic-solution shaking process to all three processes, pointed as items (a) to (c), or to just a portion of the three processes.

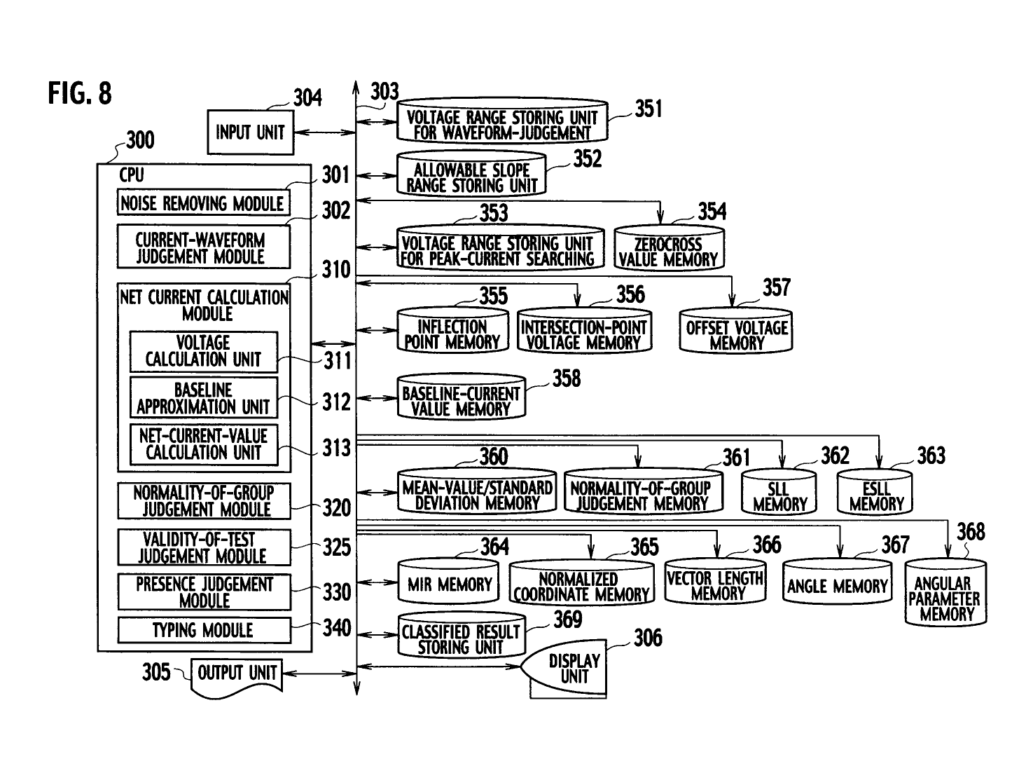

The computer (genotyping system) 16 shown in FIG. 7 encompasses: an input unit 304 for receiving input information such as data and commands from an operator as shown in FIG. 8; a central processing unit (CPU) 300 for determining whether a target nucleic acid is present or not, which of two SNP types a nucleic acid is, whether it is a homogenous type, or whether it is a hetero-type; an output unit 305 or a display unit 306 for outputting the results of the determination; a data storage portion (illustration omitted) for storing predetermined data and the like necessary for nucleotide sequence determination; and a program storage portion (illustration omitted) for storing a nucleotide sequence determination program and the like.

The CPU 300 encompasses a noise removing module 301, a current-profile judgement module 302, a net current calculation module 310, a normality-of-group judgement module 320, a validity-of-test judgement module 325, a presence judgement module 330 and a typing module 340.

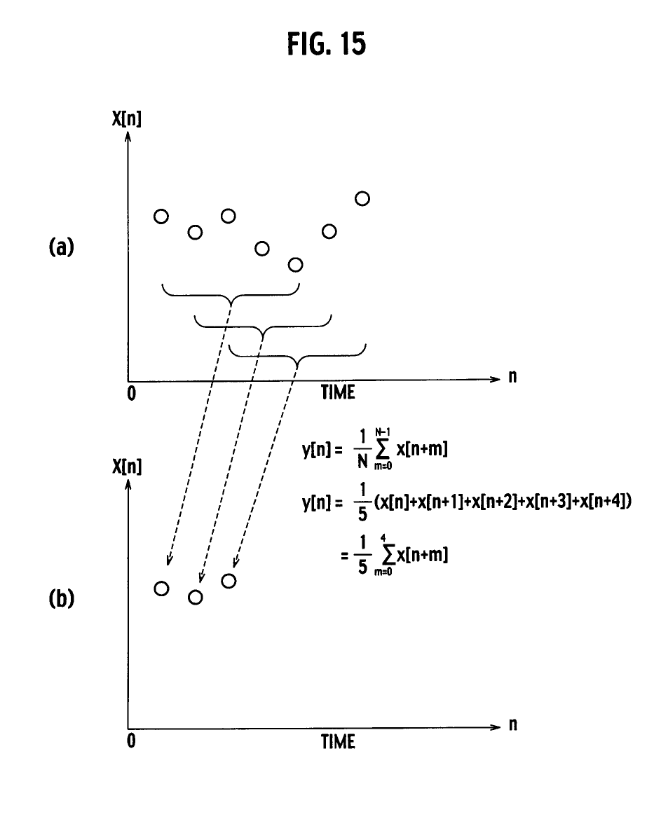

The noise removing module 301 removes noise by smoothing the current measured through an SNP1 detecting electrode 551, an SNP2 detecting electrode 552, and a control electrode 553 shown in FIG. 2, based on a “simple moving average method.” The smoothing may utilize a simple moving average method, for example, as shown in FIG. 15. Literally, the “simple moving average method” simply averages out several actual values, for example, time-series data as shown in FIG. 15(a) focusing on its regularity. In FIG. 15, setting the interval of the moving averages to be m=5, the figure obtained by dividing the data from five points in series by five:

y[n]=(x[n]+x[n+1]+x[n+2]+x[n+3]+x[n+4])/5 (2)

becomes the moving average in FIG. 15(b). As shown in FIG. 15(b), the moving average smoothes the dispersion in FIG. 15(a), which facilitates the analysis of a general trend.

The current-profile judgement module 302 calculates the slope of the tail line (characteristic baseline) of the current waveform (current-voltage characteristic) respectively measured by the SNP1 detecting electrode 551, the SNP2 detecting electrode 552, and the control electrode 553 shown in FIG. 2. Based on each slope of the tail line (characteristic baseline), it determines whether the respective detection signal (current waveform) is normal or abnormal, and abnormal detection signals are excluded from the calculation.

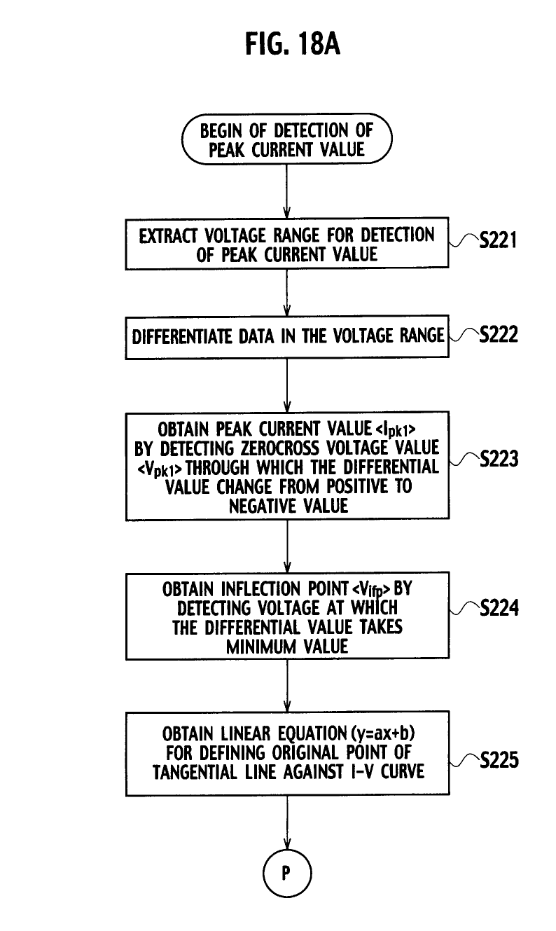

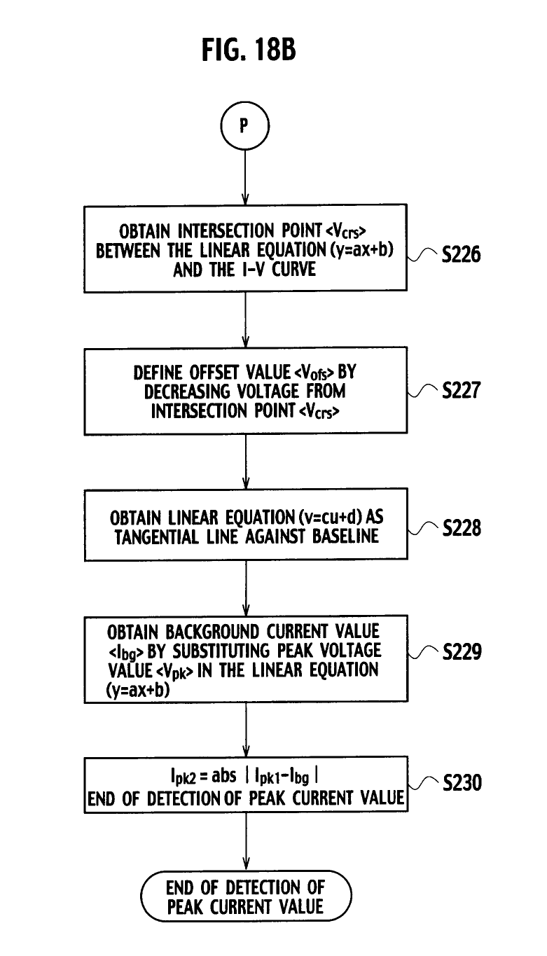

The net current calculation module 310 contains a voltage calculation unit 311, a baseline approximation unit 312, and a net-current-value calculation unit 313. According to the procedure described in a flowchart in FIG. 18A and FIG. 18B, it calculates a peak value (peak current value) of true electrochemical current (true detection signal) derived from a intercalation agent 591 by subtracting background current from the current (detection signal) measured by the SNP1 detecting electrode 551, the SNP2 detecting electrode 552, and the control electrode 553.

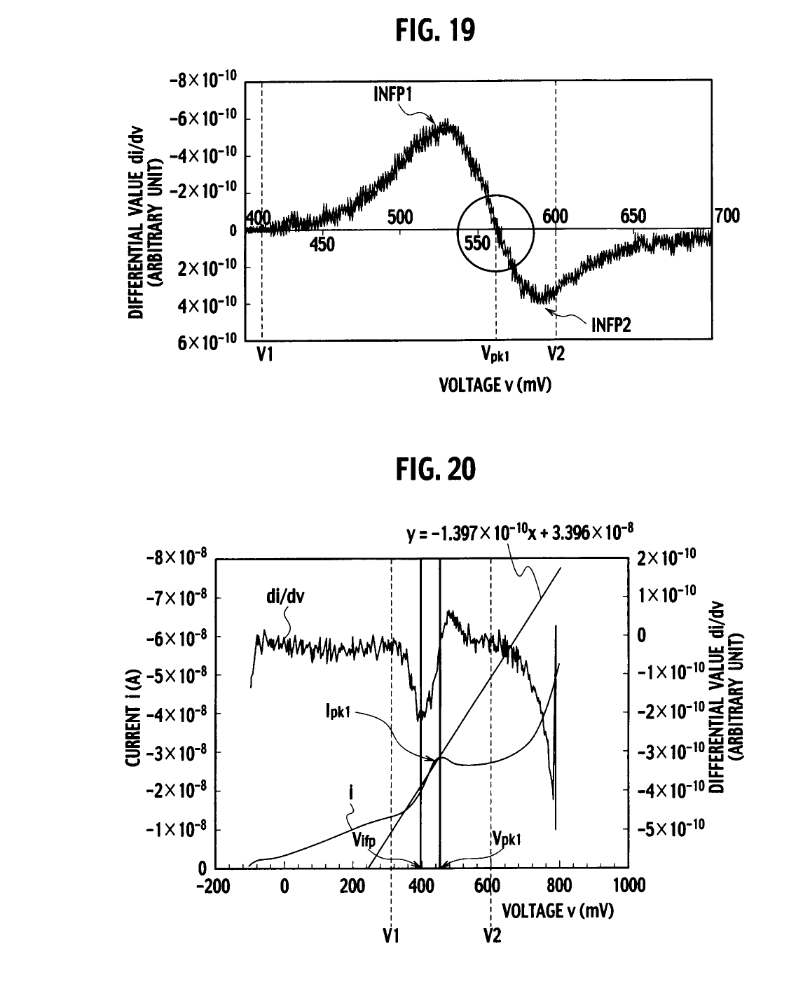

The voltage calculation unit 311, according to procedure described in steps S221-S223 of FIG. 18A, differentiates the electrochemical current (i), which represents a waveform of the current (i)−voltage (v) characteristic measured by the chip cartridge 11, with respect to the voltage value (v). Then, in a range between a predetermined lower limit value V1 and upper limit value V2, the voltage calculation unit 311 determines the voltage value Vₚₖ₁ and the current value Iₚₖ₁ at the point where the differential curve (di/dv) “zero-crosses” with respect to each of the current-voltage characteristics measured by the plurality of electrode units 761 respectively (see FIG. 19.). The point of “zero-cross” refers to a point in which the differential curve (di/dv) of the electrochemical current varies from positive to negative or from negative to positive, which corresponds to the voltage value Vₚₖ₁ and the current value Iₚₖ₁ that give a current peak. FIG. 19 shows a dispersion of the differential value (di/dv) varies with the voltage values, indicating the voltage value Vₚₖ₁ and the current value Iₚₖ₁ at the point where the differential value (di/dv) varies from negative to positive as the voltage value increases. When there is an odd number of “zero-cross values”, the center value is adopted as the voltage value Vₚₖ₁. In order that “zero-cross values” do not suffer from the influence caused by the noise and the bad influence caused by the setting condition of the peak detection range (between the lower limit value V1 and the upper limit value V2), the voltage value of the point, which firstly exhibits the positive value when the successive three points, which are the points after changing to the positive value from the negative value, hold the positive value, is assigned as the voltage value Vₚₖ₁.

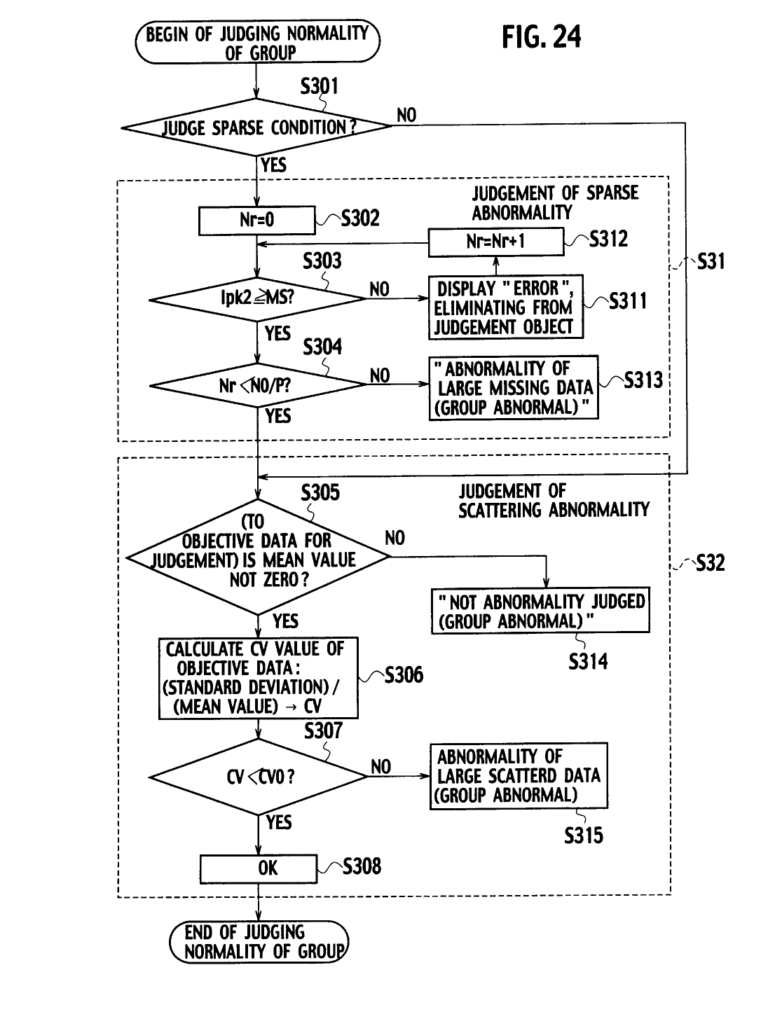

The normality-of-group judgement module 320 according to a sequence of process-steps shown in a flowchart in FIG. 24, eliminates abnormal data from a data group of the peak values (peak current values) of the true electrochemical currents (the true detection signals), which are calculated by the net current calculation module 310, and then judges whether or not the data group is the data group suitable for the subsequent type judgment execution. That is, the normality-of-group judgement module 320 eliminates the data that does not satisfy a predetermined standard, as the abnormal value, from the data group of the current values Iₚₖ₂ that are measured through the plurality of SNP1 detecting electrodes 551, the plurality of SNP2 detecting modules 552 and the plurality of control electrodes 553, respectively, which are respectively distributed in the plurality of electrode units 761 arranged on the substrate 714 as shown in FIG. 4 (a sparse abnormality judgment at step S31), and if the predetermined standard is not satisfied in the group unit, its group is judged to be abnormal, and it is eliminated from the calculation target in the judging module after that (a scattering abnormality judgment at step S32).

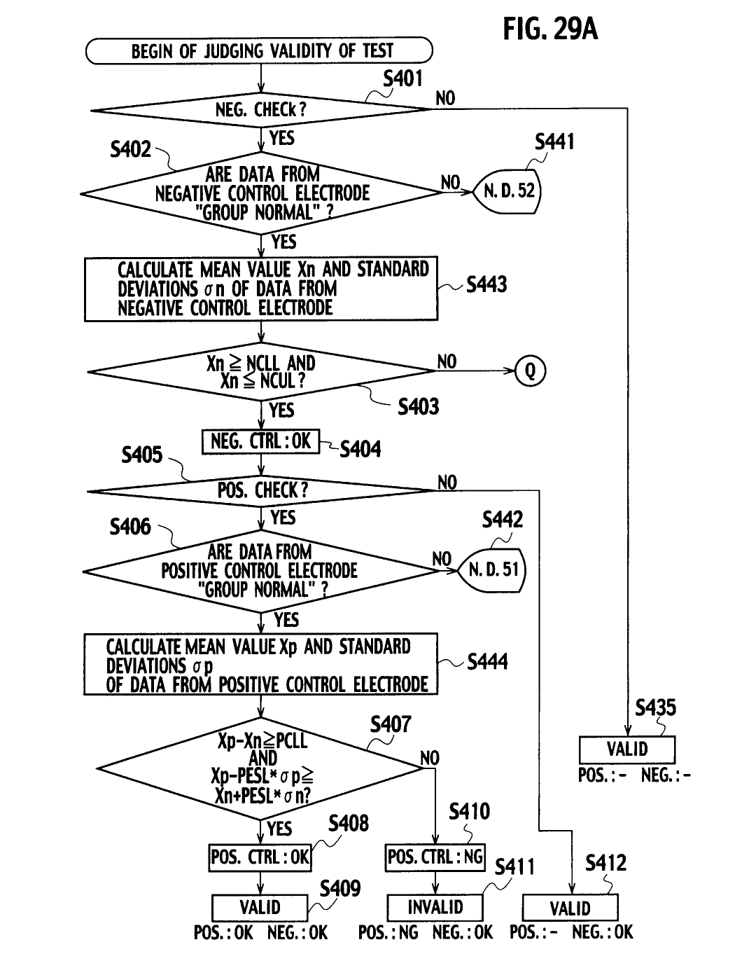

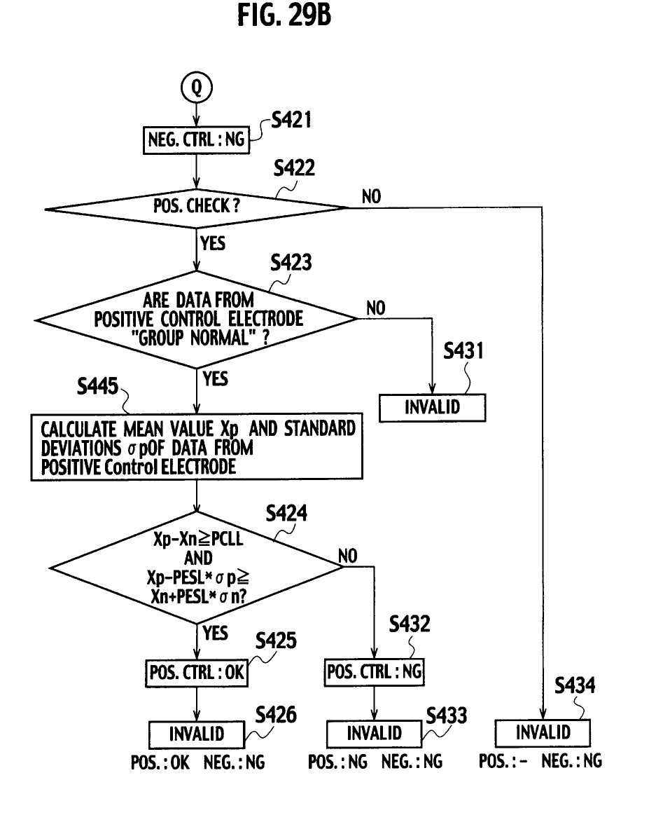

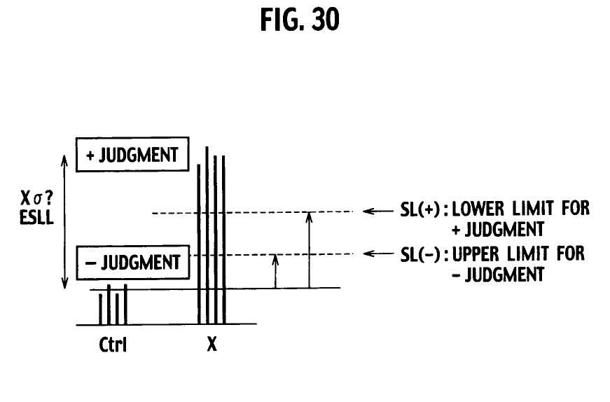

The validity-of-test judgement module 325 judges whether or not the test is valid, according to a sequence of process-steps shown in flowcharts shown in FIGS. 29A and 29B. That is, positive control currents detected by a plurality of positive control electrodes (action electrodes) 554, which are distributed in the plurality of electrode units 761, respectively, arranged on the substrate 714 shown in FIG. 4, and negative control currents detected by the negative control electrodes (action electrodes) 555 are compared with a predetermined standard value, with regard to the magnitude relation. Then, if a set of negative control currents is smaller than the predetermined standard and if a set of positive control currents is greater than the predetermined standard, the test is judged to be valid. Then, the operational flow proceeds to the step of calculation in the judging module after that.

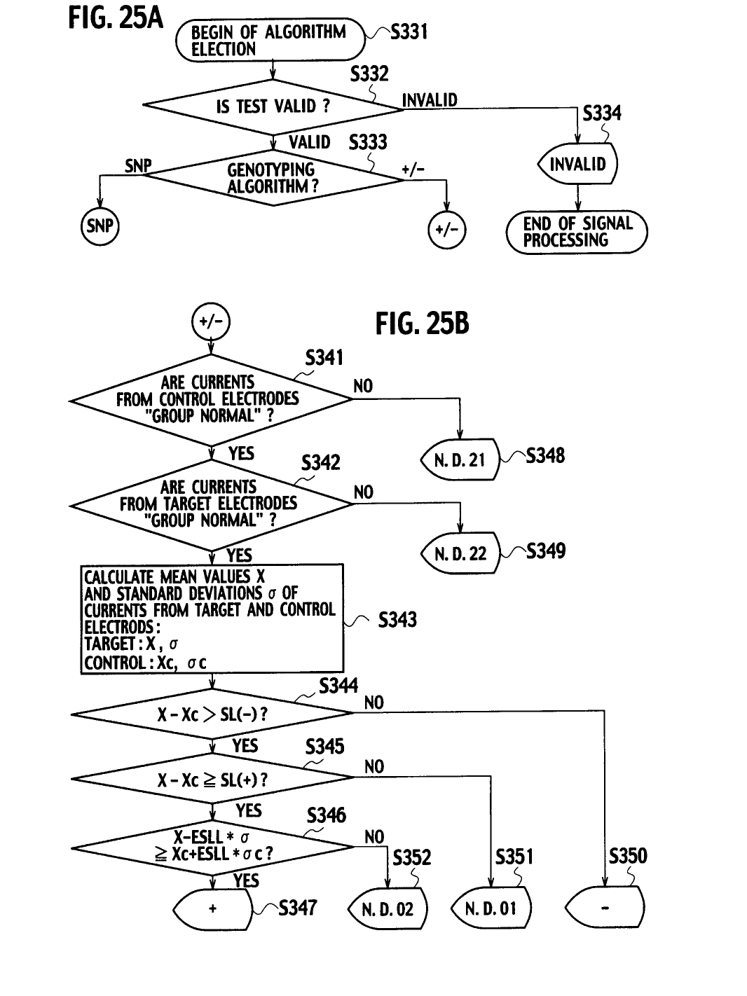

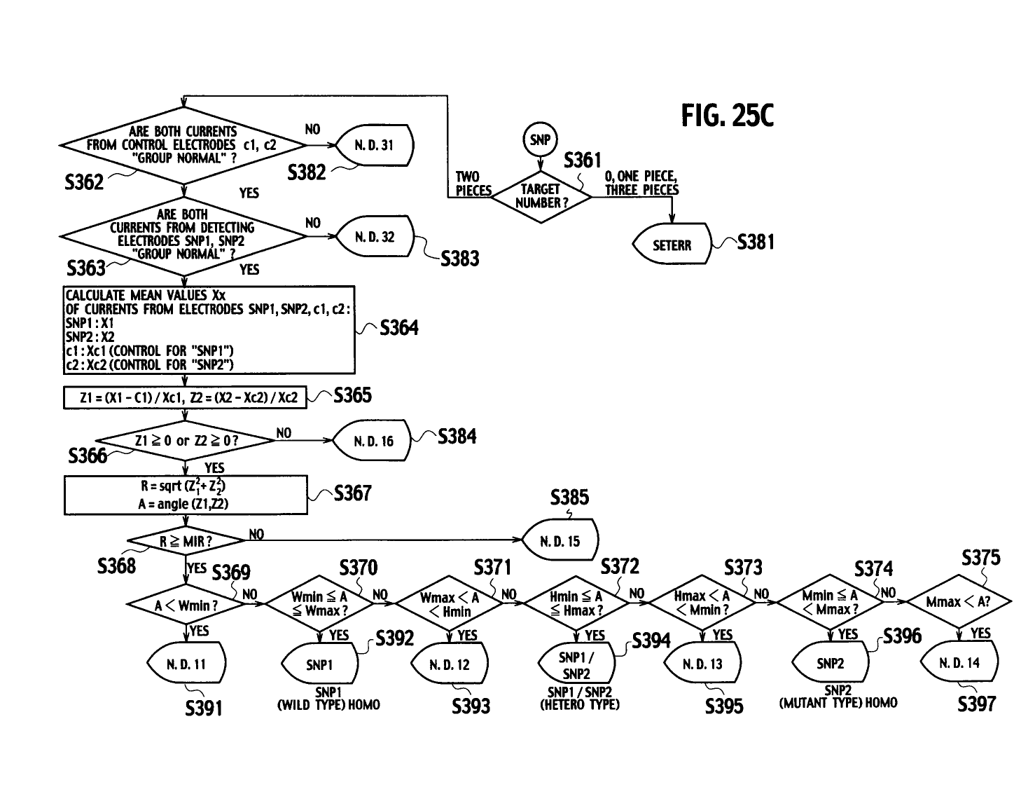

The presence judgement module 330 determines whether or not the target nucleic acid is present, according to a sequence of process-steps shown in a flowchart in FIG. 25B. The details of the process-steps shown in FIG. 25B will be described later.

The typing module 340, according to a sequence of process-steps shown in a flowchart in FIG. 25C, determines the SNP type as SNP=“G” or SNP=“T”. Furthermore, the typing module 340 classifies the SNP types into a G/G homo-type, a G/T hetero-type, or a T/T homo-type, and the like. The details of the process-steps shown in FIG. 25C will be described later.

As shown in FIG. 8, a voltage range storing unit (for waveform-judgement) 351, a allowable slope range storing unit 352, a voltage range storing unit (for peak-current searching) 353, a zero-cross value memory 354, an inflection point memory 355, an intersection-point voltage memory 356, an offset voltage memory 357, a baseline-current value memory 358, a mean-value/standard deviation memory 360, a normality-of-group judgment memory 361, a signal limit level (SLL) memory 362, an effective signal lower limit (ESLL) memory 363, a minimum increase ratio (MIR) memory 364, a normalized coordinate memory 365, a vector length memory 366, an angle memory 367, an angular parameter memory 368 and a classified-result storing unit 369 are connected through a bus 303 to the CPU 300.

The voltage range storing unit (for waveform-judgement) 351 stores “lower limit voltage VLo” and “higher limit voltage VHi (VLo<VHi)” as a range of calculating the slopes of the tail lines (characteristic baselines) of the currents (detection signals) measured by the plurality of SNP1 detecting electrode 551, the plurality of SNP2 detecting electrode 552, and the plurality of control electrode 553, respectively. The allowable slope range storing unit 352 stores “lower limit slope value (Coef Lo)” and “higher limit slope value (Coef Hi)” as parameters for the current-profile judgement module 302 to determine allowable values of the slopes of the tail lines (characteristic baselines) of the detection signals.

The voltage range storing unit (for peak-current searching) 353 stores a predetermined peak-current-searching voltage range [V1, V2] as a predetermined parameter, which facilitates the voltage calculation unit 311 to read out the peak-current-searching voltage range [V1, V2]. The position of the current peak indicated by the current-voltage characteristic of the electrochemical current will appear within a substantially constant voltage range if the measurement conditions are fixed. Therefore, the peak-current-searching voltage range [V1, V2] is determined as the predetermined parameter. The zero-cross value memory 354 sorts and stores the “zero-cross values (zero-cross voltage values Vₚₖ₁ zero-cross current values Iₚₖ₁)” in each of all electrode units 761 on the substrate 714 shown in FIG. 4.

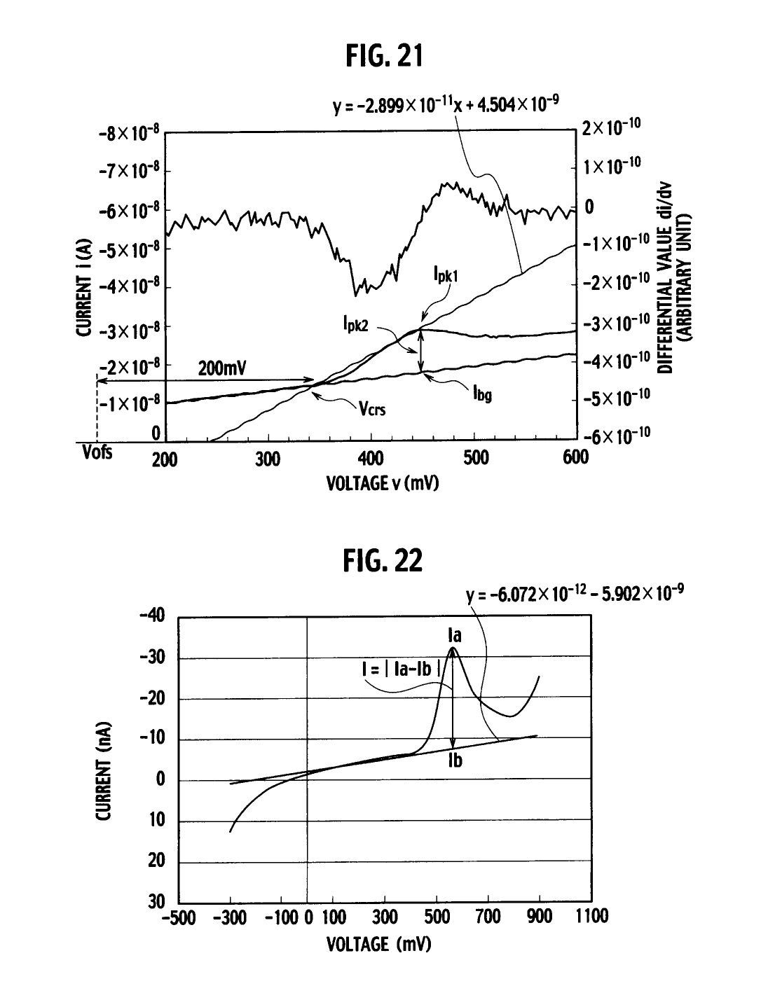

The inflection point memory 355 stores the inflection point voltage V_{ifp} required for calculation by the baseline approximation unit 312. The “inflection point voltage V_{ifp}”, as shown in FIG. 20, is the voltage at which the differential curve is minimized by tracing the voltage, in a negative direction (by decreasing the voltage), from the zero-cross voltage value Vₚₖ₁ that gives the current peak. The intersection-point voltage memory 356 stores the intersection-point voltage The “intersection-point voltage Vₑᵣₛ”, as shown in FIG. 21, is the voltage given by the intersection-point with the approximate linear expressions of the current-voltage characteristic curve of the electro-chemical current and this current-voltage characteristic curve. The offset voltage memory 357, as shown in FIG. 21, stores the offset voltage V_{ofs} obtained by tracing the voltage starting from the intersection-point voltage value Vₑᵣₛ as much as the offset value defined as a predetermined parameter in a negative direction (by decreasing the voltage).

The baseline-current value memory 358 stores a plurality of baseline (background) current values I_{bg} required for calculation by the net-current-value calculation unit 313. Each of the “baseline (background) current values I_{bg}”, as shown in FIG. 21, is the current value serving as background, which can be obtained by substituting the zero-cross voltage value Vₚₖ₁ calculated by the voltage calculation unit 311 into the approximate linear expression of the baseline calculated by the baseline approximation unit 312.

The mean-value/standard deviation memory 360 stores the mean-value X, obtained from measurement by the plurality of positive control electrode 554, the mean-value Xₙ obtained from measurement by the plurality of negative control electrode 555; the mean-value X obtained from measurement by the plurality of presence-detecting electrode 551 (here, the SNP1 detecting electrodes 551 shown in FIG. 2 are assigned as the active electrode, respectively for detecting the target nucleic acid), the mean-value X_{c} obtained from measurement by the plurality of control electrode (C) 553 corresponding to the presence-detecting electrode 551, the mean-value X₁ obtained from measurement by the plurality of SNP1 detecting electrode 551, the mean-value X_{c1} obtained from measurement by the plurality of control electrodes (C) 553 corresponding to the SNP1 detecting electrode 551, the mean-value X₂ obtained from measurement by the plurality of SNP2 detecting electrode 552, the mean-value X_{c2} obtained from measurement by the plurality of control electrode (C2) 553 corresponding to the SNP2 detecting electrode 552, the standard deviationsigmaₚ of the peak current values obtained from measurement by the plurality of positive control electrode 554, the standard deviationsigmaₙ of the peak current values obtained from measurement by the plurality of negative control electrode 555, the standard deviationsigma of the peak current values obtained from measurement by the plurality of the presence-detecting electrode 551, the standard deviation sigma, of the peak current values obtained from measurement by the plurality of the corresponding control electrode 53, the standard deviationsigma₁ of the peak current values obtained from measurement by the plurality of the SNP1 detecting electrode 551, the standard deviation sigma_{c1} of the peak current values obtained from measurement by the plurality of the corresponding control electrode 553, the standard deviationsigma₂ of the peak current values obtained from measurement by the plurality of the SNP2 detecting electrode 552, the standard deviationsigma₂ of the peak current values obtained from measurement by the plurality of the corresponding control electrode 553 and the like, which are calculated by the normality-of-group judgement module 320, the validity-of-test judgement module 325, the presence judgement module 330 and the typing module 340, respectively. Those mean-values X, Xₚ, Xₙ, X₁, X_{c1}, X₂ and X_{c2} and the standard deviation sigma, sigmaₚ, sigmaₙ, sigma₁, sigma_{ct}, sigma₂, sigma_{c2}, and the like are read out in response to each of the request of the calculations of the normality-of-group judgement module 320, the validity-of-test judgement module 325, the presence judgement module 330 and the typing module 340, at any time.

The normality-of-group judgment memory 361 stores various numbers Nrs of the insufficient currents that will contribute the sparse abnormality, various coefficient of variance (CV) values CVs, which are calculated by the normality-of-group judgement module 320, a minimum signal criterion MS for judging an insufficient current, an allowable sparse rate P and a standard CV value CV0 (%) that are necessary for the calculation in the normality-of-group judgement module 320 and the like. The “CV value” refers to the value obtained by multiplying the resulting value of dividing the standard deviation of the subject set of data by the corresponding mean-value by 100 and is indicated as a percentage. Since the dispersion or variance has a unit of a sample, the degree of dispersion for the two sample groups cannot be compared. Therefore, the value was divided by the respective mean-value to give an absolute number. The signal limit level (SLL) memory 362 stores a negative control lower limit (NCLL) setting parameter NCLL and stores a negative control upper limit (NCUL) setting parameter NCUL, both are necessary for the calculations in the validity-of-test judgement module 325, a positive control lower limit (PCLL), signal-increment criterions SL(+) and SL(−), which are necessary for the calculations in the presence judgement module 330 (See FIG. 30). The respective parameters stored in the SLL memory 362 are the setting parameters to give the judgment standard of a judging algorism of a signal increment for the control electrode 553. The effective signal lower limit (ESLL) memory 363 stores a setting parameter of a positive control effective signal lower limit (PESL) necessary for the calculation in the validity-of-test judgement module 325, and a setting parameter of an effective signal lower limit (ESLL) necessary for the calculation in the presence judgement module 330. The setting parameters PESL and ESLL are predetermined parameters that provides the lower limits of determination regarding how many folds the signal increase is, in comparison with the standard deviation sigma. That is, these parameters serve as the indexes representing the reliability of the signal increase.

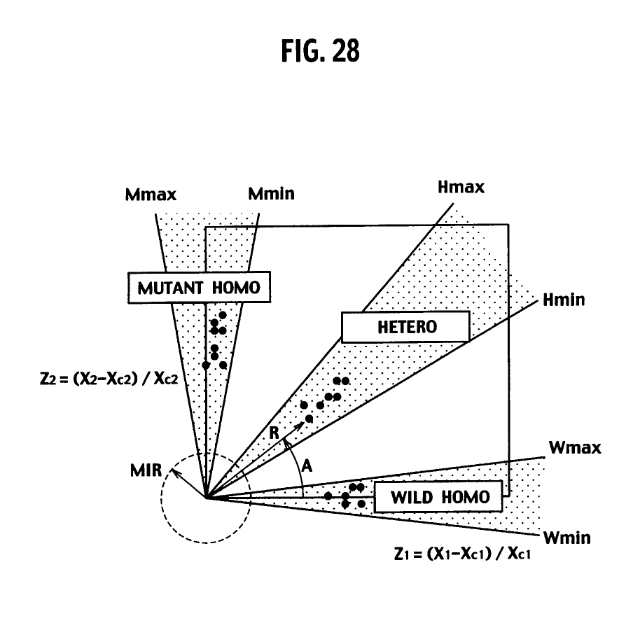

The minimum increase ratio (MIR) memory 364 stores a current-increment-rate criterion MIR necessary for the calculation in the typing module 340. The current-increment-rate criterion MIR is the setting parameter to give the lower limit of the ratio to the control current value of the current-increment necessary for the type judgment. In a concept image view of FIG. 28 indicating various parameters as criterion, MIR is shown as the distance from origin. This implies that, when the increment of the mean-value X₁ obtained through the SNP1 detecting electrodes 551 from the mean-value X_{c1} obtained through the control electrodes (C1) 553 corresponding to the SNP1 detecting electrodes 551 and the increment of the mean-value X₂ obtained through the SNP2 detecting electrodes 552 from the mean-value X_{c2} obtained through the control electrodes (C2) 553 corresponding to the SNP2 detecting electrodes 552 are small (when the data point are located at the position closer to origin than the circle of a radius MIR), the current values required by the system are not obtained, which disables the execution of the type judgment (this situation is labeled as “not determined”).

The angular parameter memory 368 stores a wild type lower limit angle Wₘᵢₙ, a wild type upper limit angle Wₘₐₓ, a hetero type lower limit angle Hₘᵢₙ, a hetero type upper limit angle Hₘₐₓ, a mutant type lower limit angle Mₘᵢₙ and a mutant type upper limit angle Mₘₐₓ, which are necessary for the calculation in the typing module 340. In a concept image view of FIG. 28 indicating various angle judgment criteria, and when an angle between the vector from origin to a data point and the positive X-axis lies in an area between the wild type lower limit angle Wₘᵢₙ and the wild type upper limit angle Wₘₐₓ, the data point is judged to be the wild type. When the angle between the vector and the positive X-axis lies in an area between hetero type lower limit angle Hₘᵢₙ and hetero type upper limit angle Hₘₐₓ, the data point is judged to be hetero type, and when the angle lies in an area between the mutant type lower limit angle Mₘᵢₙ and the mutant type upper limit angle Mₘₐₓ, the data point is judged to be the mutant type. In the example shown by the angle “A” in FIG. 28, the data point is judged to be hetero type. The classified-result storing unit 369 stores various classification results classified by the presence judgement module 330 and the typing module 340.

Although the illustration is omitted, an interface is connected to the CPU 300 via the bus 303, and it is possible to send/receive data with the control mechanism 15 shown in FIG. 7 through the local bus (not shown) via the interface.

In FIG. 8, a keyboard, mouse, light pen, or flexible disk drive, and the like may implement the input unit 304. Using the input unit 304, an operator performing nucleotide sequence determination can designate the input/output data and determine a plurality of required predetermined parameters, allowable error value, and error level. Furthermore, using the input unit 304, it is possible to determine a form of the output, and the like and to receive instructions for conducting or canceling calculations. The output unit 305 and the display unit 306 may be implemented by, for example, a printer unit and a display unit, and the like. The display unit 306 displays such items as input/output data, determination results, and determination parameters. The data memory (not shown) stores items such as input/output data, determination parameters and history of the determination parameters, and data in calculations.

As explained above, the nucleotide sequence determination system according to the embodiment of the present invention facilitates determination of the presence of nucleic acid and classification of homo/hetero-types of SNP with a high degree of accuracy in line with actual conditions.

(Nucleotide Sequence Determination Method)

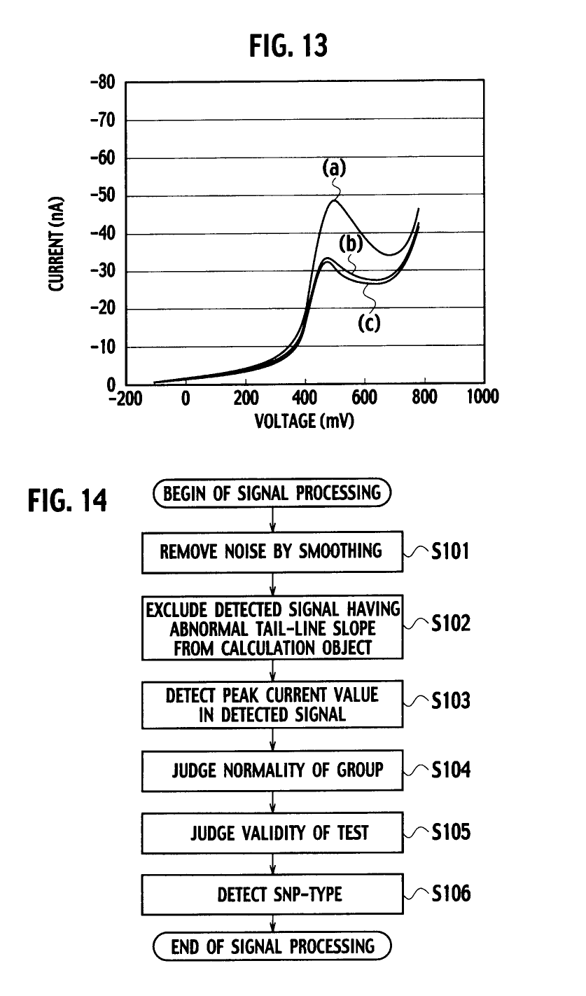

Referring to a flowchart shown in FIG. 14, the nucleotide sequence determination method according to the embodiment of the present invention will be explained. The nucleotide sequence determination method described below is one example. Including modifications, various other nucleotide sequence determination methods are of course feasible. Whatever the case, it is basic to obtain the current-voltage characteristic of electrochemical current as shown in FIG. 13 by using the detecting system 12 through the electrochemical reaction by inducing a hybridization reaction by injecting chemicals (sample solution) containing samples DNA 581, 582, 583 into the chip cartridge 11 where probe DNAs 571, 572, 573 shown in FIG. 3 are fixed, washing with the buffer solution, and introducing intercalation agents. From the current-voltage characteristic of electrochemical current, a peak current value that quantitatively corresponds to the hybridization reaction of each probe DNAs 571, 572, 573 is determined. Then, the calculated peak current value data is statistically processed, and thereby the presence of nucleic acid or the type of SNPs of nucleic acid is determined. Prior to the explanation of the flowchart shown in FIG. 14, referring to FIGS. 9A-9C, FIGS. 10A-10C, and FIGS. 11A-11C, the hybridization of probe DNA and sample DNA will be explained. The chip cartridge 11 shown in FIG. 4 and FIG. 5 may be used for the hybridization process.

FIGS. 9A-9C show three cases in which the sample DNA 581 is assigned as a target nucleotide sequence having a nucleotide sequence CTGAG . . . (sample DNA with SNP=“G”). As shown in FIG. 9A, the active electrode (SNP1 detecting electrode) 551 at which the first probe DNA 571 having a nucleotide sequence GACTC . . . is fixed forms a double-strand with the target nucleotide sequence (sample DNA with SNP=“G”) 581, since their sequences completely match. However, if the sequence contains even one different base, a double-strand cannot be formed. Accordingly, as shown in FIG. 9B, the active electrode (SNP2 detecting electrode) 552 at which the second probe DNA 572 having a nucleotide sequence GAATC . . . is fixed cannot form a double-strand with the target nucleotide sequence (sample DNA with SNP=“G”) 581.

If the sequence is completely different, it naturally cannot form a double-strand. Therefore, as shown in FIG. 9C, the active electrode (control electrode) 553 at which the probe DNA (negative control DNA) 573 having a nucleotide sequence CAGTG . . . is fixed cannot form a double-strand with the target nucleotide sequence (sample DNA with SNP=“G”).

FIGS. 10A-10C show three cases in which the sample DNA 582 is a target nucleotide sequence having a nucleotide sequence CTTAG . . . (SNP=“T” of sample DNA). Similarly, through the hybridization process by the chip cartridge 11, as shown in FIG. 10B, the active electrode (SNP2 detecting electrode) 552 can form a double-strand, since the sequence completely matches with the target nucleotide sequence having a nucleotide sequence CTTAG . . . (sample DNA with SNP=“T”). However, if the sequence contains even one different base, a double-strand cannot be formed. Accordingly, as shown in FIG. 10A, the active electrode (SNP1 detecting electrode) 551 at which the first probe DNA 571 having a nucleotide sequence GACTC . . . is fixed cannot form a double-strand with the target nucleotide sequence (sample DNA with SNP=“T”) 582. If the sequence is completely different, a double-strand, of course, cannot be formed. Therefore, as shown in FIG. 10C, the active electrode (control electrode) 553 at which the probe DNA (negative control DNA) 573 having a nucleotide sequence CAGTG . . . is fixed cannot form a double-strand with the target nucleotide sequence (sample DNA with SNP=“T”) 582.

FIGS. 11A-11C show three cases in which the sample DNA 583 is a target nucleotide sequence (sample DNA with SNP=“G”) having a nucleotide sequence CTGAG . . . . Similarly, through the hybridization process by the chip cartridge 11, as shown in FIG. 11A, the active electrode (SNP1 detecting electrode) 551 at which the first probe DNA 571 having GACTC . . . is fixed can form a double-strand, since the sequence completely matches with the “G/T” hetero target nucleotide sequence 583 having both nucleotide sequences CTGAG . . . and CTTAG . . . (sample DNA with SNP=“G/T” hetero). As shown in FIG. 11B, the active electrode (SNP2 detecting electrode) 552 at which the second probe DNA 572 having a nucleotide sequence GAATC . . . is fixed can form a double-strand, since the sequence completely matches with the target nucleotide sequence (sample DNA with SNP=“G/T” hetero) 583. However, if the sequence is completely different, a double-strand, of course, cannot be formed. Therefore, as shown in FIG. 11C, the active electrode (control electrode) 553 at which the probe DNA (negative control DNA) 573 having a nucleotide sequence CAGTG . . . is fixed cannot form a double-strand with the “G/T” hetero target nucleotide sequence (sample DNA with SNP=“G/T” hetero) 583.

When adopting another architecture that is different from the configuration shown in FIG. 4 and FIG. 5, that is, when adopting a configuration that mounts a planar packing-plate on the substrate (chip) and forms a flow path within a cassette (chip cartridge), the flow path within a cassette (detection chip) 21 is extended, which increases the amount of unnecessary reagent. In addition, when injecting automatically chemicals (reagent solution) in the cassette (detection chip) 21 by valve unit 705 provided in the fluid transport system 13 as shown in FIG. 6, the flow path remains long not only on the substrate but also within the cassette (detection chip) 21. Therefore, the chemicals (sample solution) flow into undesired parts other than the substrate, which results in waste. In addition, as a result of insufficient adhesion of the cassette (detection chip) 21 to the packing-plate, leakage occurs between the packing-plate and the cassette (detection chip) 21 leading to failures in solution delivering. The configuration according to the present embodiment reduces the amount of unnecessary reagent, improves the adhesion of packing-plate, substrate and cassette (detection chip) 21, and increases the stability of solution conveyance.

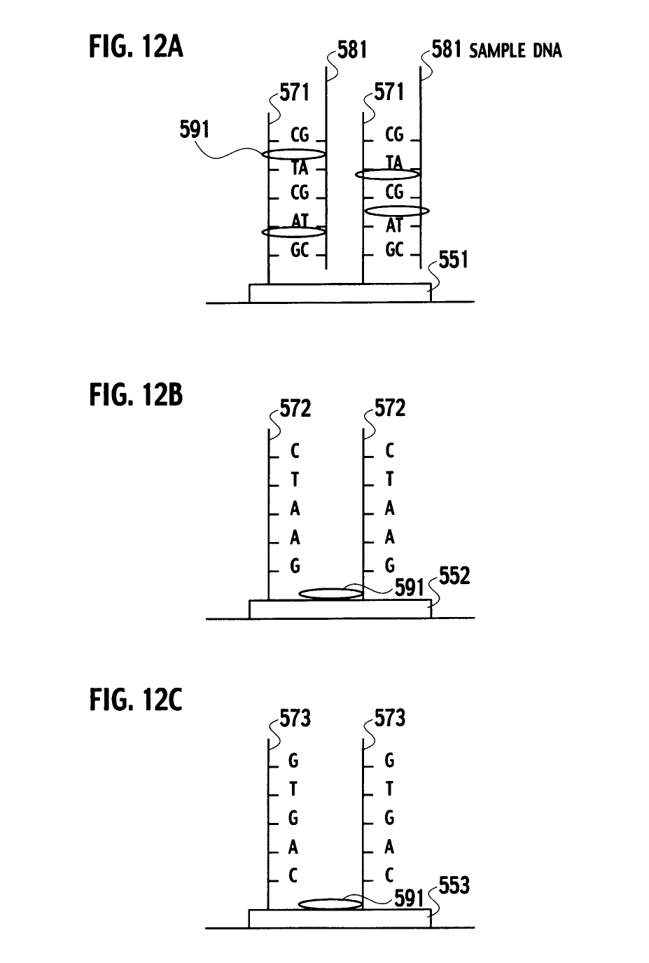

Similarly to the above-mentioned FIGS. 9A-9C, FIGS. 12A-12C show three conditions in which the intercalation agent 591 is introduced in each of active electrodes 551, 552, 553 that is hybridized by the target nucleotide sequence (sample DNA) 581 having a nucleotide sequence CTGAG . . . . As shown in FIG. 12A, for the active electrode (SNP1 detecting electrode) 551 at which the first probe DNA 571 having a nucleotide sequence GACTC . . . is fixed, the sequence completely matches the target nucleotide sequence (sample DNA) 581 having a nucleotide sequence CTGAG . . . ; therefore, the intercalation agent 591 bonds to the double-strand DNA. However, as shown in FIG. 12B, the active electrode (SNP2 detecting electrode) 552 at which the second probe DNA 572 having a nucleotide sequence GAATC . . . is fixed cannot form a double-strand with the target nucleotide sequence (sample DNA) 581; therefore, the intercalation agent 591 cannot be intercalated. Also as shown in FIG. 12C, the intercalation agent 591 cannot be intercalated to the active electrode (control electrode) 553 at which the probe DNA (negative control DNA) 573 having a nucleotide sequence CAGTG . . . is fixed, since it cannot form a double-strand with a target nucleotide sequence (sample DNA) 581.

FIG. 13 shows an electrochemical current from the intercalation agent 591 intercalated to the double-strand DNA hybridized to the probe DNAs 571, 572, 573 that are fixed on each of active electrodes 551, 552, 553 or a relation between current and voltage when the intercalation agent 591 cannot be intercalated to the double-strand DNA. In FIG. 13, a curved line labeled with (a) corresponds to FIG. 12A. Briefly, the curved line labeled with (a) refers to the current-voltage characteristic of electrochemical current when the first probe DNA 571 sequence and the target nucleotide sequence (sample DNA) 581 completely matches, forms a double-strand, and the intercalation agent 591 is intercalated with the double-strand, and indicates a peak of high current value.

However, in FIG. 13, a curved line labeled with (b), corresponding to FIG. 12B, refers to the current-voltage characteristic of electrochemical current when the second probe DNA 572 cannot form a double-strand with the target nucleotide sequence (sample DNA) 581, and the intercalation agent 591 cannot be intercalated and indicates a peak of low current value compared to the curved line labeled with (a). In addition, in FIG. 13, a curved line labeled with (c), corresponding to FIG. 12C, refers to the current-voltage characteristic when the negative control DNA 573 cannot form a double-strand with the target nucleotide sequence (sample DNA) 581 and the intercalation agent 591 cannot be intercalated, and indicates a peak of lower current value compared to the curved line labeled with (b). The low current value peaks observed in the curved lines labeled with (a), and (c), are the currents derived from the intercalation agent 591 slightly absorbed to the surface of electrode 552 and 553, as shown in FIGS. 12B and 12C.

After a long introduction, the nucleotide sequence determination method according to the embodiment of the present invention will now be explained with reference to the flowchart shown in FIG. 14:

(i) First, chemicals (sample solution) containing the sample DNA are injected into the chip cartridge 11 so as to induce the hybridization reaction. After the hybridization reaction, chemicals (reagent solution) are injected automatically into the chip cartridge 11 using valve unit 705 provided in the fluid transport system 13 as shown in FIG. 6. Using the detecting system 12, the current-voltage characteristic of the electrochemical reaction derived from introducing the intercalation agent is measured for each electrode. FIG. 4 shows a schematic plot of a plurality of electrode units 761 on the substrate 714. Corresponding to the a plurality of electrode units 761, there are many SNP1 detecting electrodes 551, SNP2 detecting electrodes 552, and control electrodes 553 at which the probe DNAs 571, 572, 573 are fixed respectively as equivalent electrodes. Corresponding to those electrodes, a great deal of data can be obtained. In step S101, the noise removing module 301 removes noise by smoothing each dataset measured for each electrode at which the probe DNAs 571, 572, 573 are fixed. The smoothing, as described above, may employ the simple moving average method as shown in FIG. 15. In the following processes, the calculations are performed on all of the data after the smoothing process.

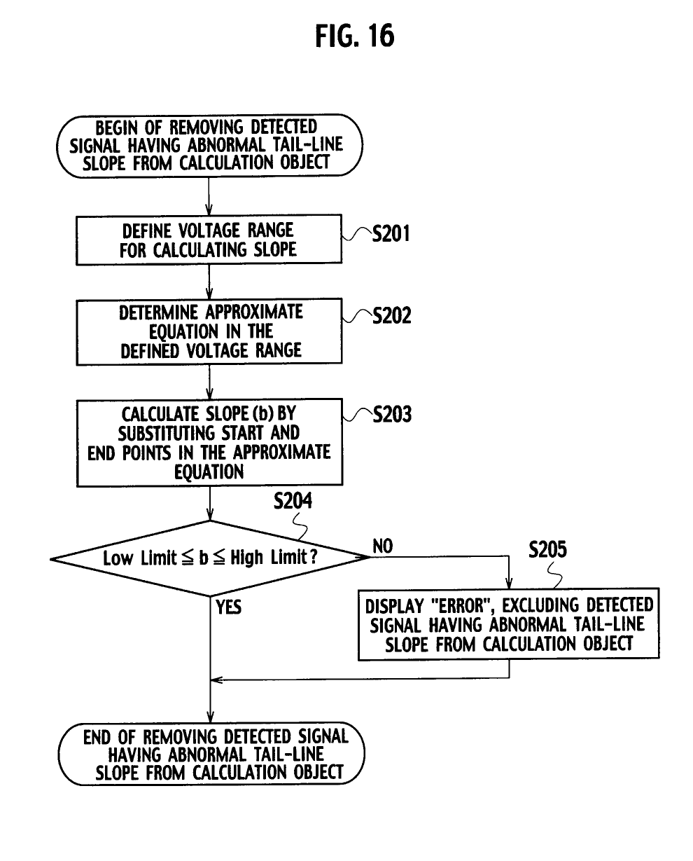

(ii) Next, in step S102, the current-profile judgement module 302 determines the respective slopes of the tail lines (characteristic baselines) in the current waveforms (current-voltage characteristics) measured for each electrode. Based on each baseline slope, the normality and abnormality of each detection signal (current waveform) are determined. The abnormal detection signal is excluded from the calculation. Details on the processing of the current-profile judgement module 302 in step S102 will be described below in reference to a flowchart in FIG. 16.

(iii) In step S103, the net current calculation module 310 detects peak values (peak current values) of the detection signals measured for each electrode respectively. Details on the processing of the net current calculation module 310 in step S103 will be described below in reference to a flowchart in FIG. 18A and FIG. 18B. By the processing in step S103, the net peak values of the detection signals (peak current values) can be obtained as a dataset for respective electrodes by subtracting the other background currents from the electrochemical currents derived from the intercalation agent 591 as shown in FIGS. 12A-12C.

(iv) After removing the background current components in step S103, each dataset is treated by a signal processing in step S104. Briefly, in step S104, the normality-of-group judgement module 320 judges whether or not the objective data group is normal. Details on the processing of the normality-of-group judgement module 320 in step S104 will be described below in reference to a flowchart in FIG. 24.

(v) After that, in step S105, the validity-of-test judgement module 325 judges whether the test is valid or invalid. Details on the processing of the validity-of-test judgement module 325 in step S105 will be described later by using flowcharts shown in FIGS. 29A and 29B.

(vi) In step S106, the presence judgement module 330 determines the presence of nucleic acid, or the typing module 340 determines the type of SNPs (SNP) of nucleic acid. Details on each processing of the presence judgement module 330 and typing module 340 in step S106 will be described below in reference to a flowchart in FIG. 25A-FIG. 25C.

According to the nucleotide sequence determination method associated with the embodiment of the present invention shown in a flowchart in FIG. 14, even when there are abnormalities in the chip cartridge 11 and the detecting system 12, and when there is dispersion in data, it is possible to precisely determine whether a certain nucleic acid exists, what the SNP type is, and whether the type is homogeneous or heterogeneous. Hereinafter, each step of the flowchart shown in FIG. 14 will be explained in detail.

Step S102: Determination of Normality/Abnormality of the Current Waveform

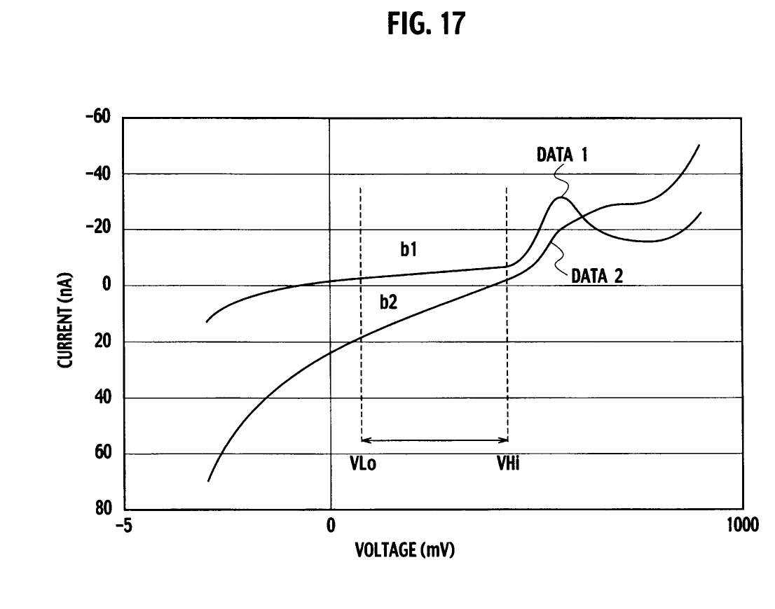

The electrochemical current signals (current waveforms) in the chip cartridge 11 measured by the detecting system 12 in FIG. 1 manifest waveforms of the current-voltage characteristics as shown in FIG. 17. For the voltage specific to substances (intercalation agents) that issue electrical signals, it has a waveform of the current-voltage characteristic having a peak shape as shown in FIG. 17. FIG. 17 shows two types of the current-voltage characteristics as labeled with “data 1” and “data 2”. Compared to the slope of the tail line (characteristic baseline) indicated by the current-voltage characteristic labeled with “data 1”, the slope of the tail line (characteristic baseline) indicated by the current-voltage characteristic labeled with “data 2” is larger. In the current-voltage characteristic labeled with “data 2”, the peak shape is unclear, showing a shoulder-like dispersion.

Ideally, the current-voltage characteristic of the electrochemical current shows a substantially “zero” current value for voltages lower than the voltage that generates a peak current. However, when any failures occur on the substrate 714, for example, a slope of the tail line (characteristic baseline) in the current-voltage characteristic becomes larger as the current-voltage characteristic labeled with “data 2”. With the current-voltage characteristic labeled with “data 2”, the peak current value cannot be detected accurately. Therefore, the current-voltage characteristic having a larger slope of the tail line (characteristic baseline) must be excluded as “abnormal” in step S102 of FIG. 14.

Details on the procedure by the current-profile judgement module 302 in step S102 are as shown in a flowchart of FIG. 16.

(a) First, in step S201, a voltage range for calculating the slopes of the tail lines (characteristic baselines) of the currents waveform (current-voltage characteristic) measured for each electrode is extracted and determined. In the case of extraction in the voltage range, the lower limit voltage VLo and the higher limit voltage VHi (VLo<VHi) are determined as predetermined parameters, using the input unit 304, and stored in the voltage range storing unit (for waveform-judgement) 351. In addition, as a parameter for specifying the allowable slope range of the tail line (characteristic baseline), “Coefficient lower limit value (Coef Lo)” and “Coefficient higher limit value (Coef Hi)” are determined and stored in the allowable slope range storing unit 352.

(b) Next, in step S202, the current-profile judgement module 302 reads out the lower limit voltage VLo and the higher limit voltage VHi stored in the voltage range storing unit (for waveform-judgement) 351, and derives an approximation expression for the slope of the tail line (characteristic baseline) in the determined voltage range. The lower limit voltage VLo and the higher limit voltage VHi are parameters to specify the voltage range for calculating the slope of the tail line (characteristic baseline). The straight line (preliminary baseline) is obtained by a least squares approximation to the current-voltage characteristic waveform measured for each electrode, using the voltage range between the lower limit voltage VLo and the higher limit voltage VHi.

(c) In step S203, the current-profile judgement module 302 calculates the slope (b) of the tail line (characteristic baseline) of the current waveform (current-voltage characteristic) measured for each electrode by setting the read lower limit voltage VLo and higher limit voltage VHi as a starting point and an ending point respectively for each current waveform (current-voltage characteristic) measured for each electrode.

(d) Thereafter, in step S204, the current-profile judgement module 302 reads out the “coefficient lower limit value (Coef Lo)” and the “coefficient higher limit value (Coef Hi)” from the allowable slope range storing unit 352, and determines if the slope of the tail line (characteristic baseline) calculated for each electrode exists between the “co-efficient lower limit value (Coef Lo)” and the “coefficient higher limit value (Coef Hi)” respectively.

(e) In step S204, when the slope of the tail line (characteristic baseline) for the current waveform (current-voltage characteristic) measured by a certain electrode exists between the “coefficient lower limit value (Coef Lo)” and “coefficient higher limit value (Coef Hi)”, it is determined as a “normal waveform”. Then, proceed to step S103 shown in FIG. 14. In step S204, the current waveform (current-voltage characteristic) measured by a certain electrode is determined to be out of the slope range between the “coefficient lower limit value (Coef Lo)” and the “coefficient higher limit value (Coef Hi)”, the current waveform (current-voltage characteristic) measured by the electrode is determined to be an “abnormal waveform”. In step S205, the current-profile judgement module 302 issues “error determination” to the current waveform (current-voltage characteristic) measured by the electrode, and, as the situation may demand, makes the display unit 306 display “error” or makes the output unit 305 transfer the “error determination” to an external device.

The sequence of process-steps shown in FIG. 16 is executed for all electrode units 761 on the substrate 714 shown in FIG. 4.

Step S103: Detection of Peak Current Value

Details on the procedure by the net current calculation module 310 in step S103 will be explained in reference to a flowchart in FIG. 18A and FIG. 18B. In step S103, the procedure for detecting respective net peak current value from the waveform of the current-voltage characteristic by each of electrode units 761 measured by the detecting system 12 is implemented by a sequence of: calculating the voltage value that gives a current peak in steps S221-S223 (see differential current value vs. voltage characteristic shown in FIG. 19); approximating the baseline (background baseline) in steps S224-S228 (see differential current value vs. voltage characteristic and current-voltage characteristics shown in FIG. 20 and FIG. 21); and calculating the peak current value in steps S229-S230 (see current-voltage characteristics shown in FIG. 22) for respective current-voltage characteristics measured by the plurality of electrode units 761.

(a) A current peak indicated by the current-voltage characteristic of the electro-chemical current measured by the chip cartridge 11 appears in a substantially constant voltage range. Therefore, in step S221, using the input unit 304 shown in FIG. 8, the peak-current-searching voltage range [V1, V2] is preliminary stored in the voltage range storing unit (for peak-current searching) 353 as a predetermined parameter.

Briefly, as shown in FIG. 19, the peak current search of the electrochemical current is conducted in a voltage range between the lower limit value V1 and the upper limit value V2. First, in step S222, the voltage calculation unit 311 of the net current calculation module 310 differentiates current (i), which represents the waveform of the current (i)−voltage (v) characteristic of the electrochemical current, with respect to the voltage value (v) so as to obtain differential curves of each of the current-voltage characteristics. Then, in step S223, the voltage calculation unit 311, in a voltage range between the lower limit value V1 and the upper limit value V2, the voltage value (zero-cross voltage value) Vₚₖ₁ and the current value (zero-cross current value) Iₚₖ₁ at the point where each of the differential curves of the electrochemical currents (di/dv) “zero-crosses” (see FIG. 19.). The point to “zero-cross” refers to the point at which each of the differential curves (di/dv) of the electrochemical currents varies from positive to negative, or alternatively from negative to positive, which corresponds to the voltage value Vₚₖ₁ and the current value Iₚₖ₁ that gives a current peak. FIG. 19 shows the voltage value Vₚₖ₁ and the current value Iₚₖ₁ at the point at which representative one of the differential curves (di/dv) varies from negative to positive as the voltage value increases. In order that “zero-cross values” do not suffer from the influence caused by the noise and the bad influence caused by the setting condition of the peak detection range (between the lower limit value V1 and the upper limit value V2), the voltage value of the point, which firstly exhibits the positive value when the successive three points, which are the points after changing to the positive value from the negative value, hold the positive value, is assigned as the voltage value Vₚₖ₁. The zero-cross value memory 354 sorts to a specified order and stores the “zero-cross value (zero-cross voltage value Vₚₖ₁, zero-cross current value Iₚₖ₁)” in each of all electrode units 761 on the substrate 714 shown in FIG. 4.

(b) In step S224, the baseline approximation unit 312 of the net current calculation module 310, define an inflection point voltage Vₐₗ, as shown in FIG. 20. The “inflection point voltage V_{ipf},” is the voltage at which each of the differential curves is minimized, by tracing the voltage from the zero-cross voltage value Vₚₖ₁ that gives the current peak, in a negative direction (by decreasing the voltage). The inflection point voltage V_{ifp} is sorted and stored in the inflection point memory 355. Then, in step S225, the baseline approximation unit 312 reads out the zero-cross voltage V_{ifp} and the inflection point voltage V_{ifp} from the zero-cross value memory 354 and the inflection point memory 355 respectively. Furthermore, in step S225, the baseline approximation unit 312 approximates the following linear expression of each of the current-voltage characteristic curves:

y=ax+b (3)

between the zero-cross voltage value Vₚₖ₁ and the inflection point voltage V_{ifp} so as to obtain an original point of the baseline (background baseline). The linear expression represented by Eq. (3) approximates the slope of the shoulder in the peaking portion of the current-voltage characteristic curve as shown in FIGS. 20 and 21. For example, the waveform data of the current-voltage characteristic between the zero-cross voltage value Vₚₖ₁ and the inflection point voltage V_{ifp} is approximated by a least square approximation. In an example of FIG. 20, the resulting coefficient “a” and constant “b” of the linear expression are:
a=−1397×10⁻¹⁰; and
b=3.396×10⁻⁸
respectively. In an example shown in FIG. 21, the resulting coefficient “a” and constant “b” of the linear expression are:
a=−2.899×10⁻¹¹; and
b=4.504×10⁻⁹
respectively. Furthermore, the baseline approximation unit 312, in step S226, calculates the intersection-point voltage Vₑᵣₛ at an intersection-point of each of the current-voltage characteristic waveforms and the corresponding approximation line of Eq. (3) as shown in FIG. 21, and each of the intersection-point voltages Vₑᵣₛ is sorted and stored in the intersection-point voltage memory 356. The baseline approximation unit 312, in step S227, defines each of the offset voltages V_{ofs} by tracing the voltage starting from the corresponding intersection-point voltage value Vₑᵣₛ, as much as the offset value defined as a predetermined parameter, in a negative direction (by decreasing the voltage) in each of the current-voltage characteristic waveforms. The obtained offset voltage V_{ofs} is sorted and stored in the offset voltage memory 357. In addition, the baseline approximation unit 312 reads out the offset voltage V_{ofs} from the offset voltage memory 357 and the intersection-point voltage Vₑᵣₛ from the intersection-point voltage memory 356. In step S228, the approximate linear expression serving as a tangential line (reference baseline) to the background of each of the waveform data for the current-voltage characteristics, between the offset voltage V_{ofs} and the intersection-point voltage Vₑᵣₛ, is obtained by method of least squares as shown in FIG. 22. The approximate linear expression can be expressed in a similar format to Eq. (3). In the linear approximation shown in FIG. 22, the resulting coefficient “a” and constant “b” of the linear expression are:
a=−6.072×10⁻¹²; and
b=5.902×10⁻⁹
respectively.

(c) Thereafter, the net-current-value calculation unit 313 of the net current calculation module 310 reads out the zero-cross voltage value Vₚₖ₁ from the zero-cross value memory 354. Then, in step S229, the net-current-value calculation unit 313 substitutes the corresponding zero-cross voltage value Vₚₖ₁ to each of the approximate linear expressions of the baselines (background baselines) obtained in step S228 to obtain a plurality of background current values I_{bg} on the baselines (background baselines) serving as reference backgrounds. The background current values I_{bg} on the baselines (background baselines) are sorted and stored in the baseline-current value memory 358. Furthermore, the net-current-value calculation unit 313 reads out the zero-cross current value Iₚₖ₁ that shows a peak of the waveform for the current-voltage characteristic from the zero-cross value memory 354. In step S230, by applying Eq. (4):

Iₚₖ₂=abs(Iₚₖ₁−I_{bg}) (4)

at which each of the current values of the baselines (background baselines) I_{bg} serving as reference backgrounds is subtracted from the corresponding zero-cross current value Iₚₖ₁ as shown in Eq. (4). The subtraction of Eq. (4) is executed to each of the current-voltage characteristics, each of which is measured by corresponding SNP1 detecting electrode (SNP=“G” detecting electrode) 551, corresponding SNP2 detecting electrode (SNP=“T” detecting electrode) 552, and corresponding control electrode 553 in each of electrode units 761. Then, a plurality of net current values Iₚₖ₂ are calculated for the plurality of electrodes 551, 552, 553 in each of the plurality of electrode units 761.

Step S104: Normality-of-Group Judgement

As described above, in step S103 in FIG. 14, the net current calculation module 310 subtracts the background current value I_{bg} of the baseline (background baseline) from the zero-cross current value Iₚₖ₁ that shows a peak of respective current-voltage characteristic derived from each of electrode units 761 measured by the detecting system 12. As a result, the respective net current values Iₚₖ₂ for a plurality of SNP1 detecting electrodes (SNP=“G” detecting electrodes) 551, a plurality of SNP2 detecting electrodes (SNP=“T” detecting electrodes) 552, and a plurality of control electrodes 553 are calculated and sorted for each of electrode units 761, with various determination modes.

However, for example, when a specific value is abnormally high or low for only one electrode within the plurality of equivalent SNP1 detecting electrodes (SNP=“G” detecting electrode) 551, or, when a specific value is abnormally high or low for only one electrode within the plurality of equivalent SNP2 detecting electrodes (SNP=“T” detecting electrode) 552, the determination algorithm is disrupted unless these abnormal values are excluded. Briefly, in the process-step S105 shown in FIG. 14, when all of the peak current values Iₚₖ₂ measured through the plurality of equivalent electrode units 761 arranged on the substrate 714 as shown in FIG. 4 are employed so as to determine whether a certain nucleic acid exists, which of two the SNP type is, and whether it is homo-type or hetero-type, problems might occur.

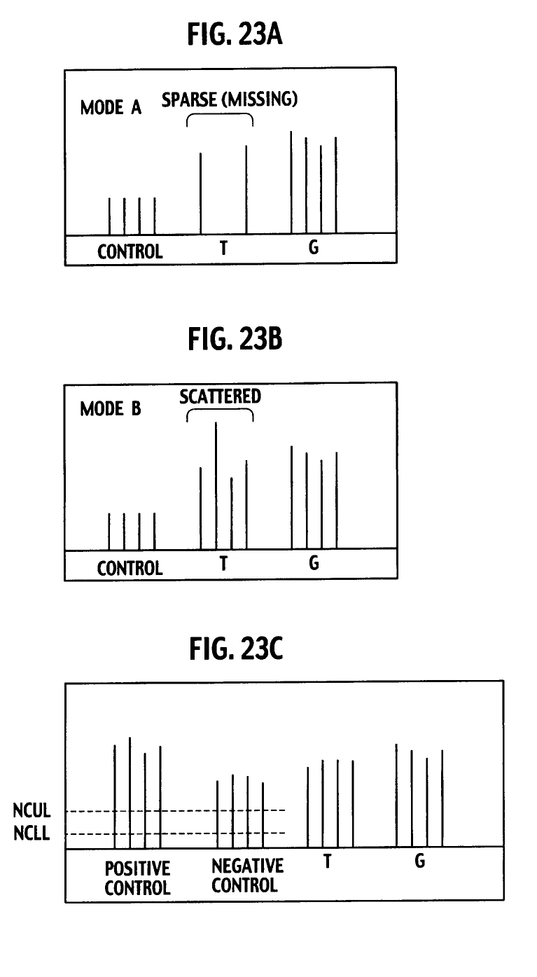

Accordingly, in step S104 of FIG. 14, prior to going to step S105, the normality-of-group judgement module 320 execute a sequence of process-steps prescribed by the flowchart shown in FIG. 24, the sequence of process-steps being executed respectively in every groups of the current values Iₚₖ₂, which are obtained from all of electrode units 761 arranged on the substrate 714 shown in FIG. 4. In the flowchart shown in FIG. 24, in step S31, the sparse abnormality is judged as shown in FIG. 23A. After that, in step S32, the scattering abnormality is judged as shown in FIG. 23B. The judgment of the sparse abnormality in step S31 and the judgment of the scattering abnormality in step S32 judge the validity of group units as to whether or not each of units of data group is worth of the subsequent judgment process, in accordance with the following predetermined criterion.

(a) In step S301, whether the normality-of-group judgement module 320 executes the sparse abnormality judgment in step S31 or not is elected. If the step of sparse abnormality judgment is elected, the sequence of process-steps proceeds to the step S302 in the step S31. If the step of sparse abnormality judgment is not elected, the sequence of process-steps jumps to the step S305 in the step S32 so as to judge the scattering abnormality.

(b) In step S302, in order to count the number Nr of the insufficient currents that will contribute the sparse abnormality, “zero” is set as the initial value of the number Nr, and the sequence of process-steps proceeds to the next step S303.

(c) In step S303, a minimum signal criterion MS for judging an insufficient current stored in the normality-of-group judgment memory 361 is read, and each of current values Iₚₖ₂ is compared with the minimum signal criterion MS, with regard to the magnitude relation. In the case that the magnitude of current values Iₚₖ₂ is equal to or larger than the minimum signal criterion MS, the data is determined not to be an insufficient current which will contribute sparse abnormality, and the sequence of process-steps proceeds to the step S304. In the case that the magnitude of current values Iₚₖ₁ is less than the minimum signal criterion MS, the data is determined to be the insufficient current which will contribute the sparse abnormality, and in step S311, an “error (data out of judgement object)” is displayed and the data is eliminated from judgement object. Moreover, in step S312, the number Nr of the insufficient current that will contribute the sparse abnormality is counted up, and the sequence of process-steps returns back to the step S303. This routine is repeated for all of the data in the group, and the final number Nr of the insufficient currents that will contribute the sparse abnormality in the group is counted. In step S303, the data that is judged not to be in the sparse data is defined as the judgment object data.

(d) In step S304, an allowable sparse rate P stored in the normality-of-group judgment memory 361 is read. Then, with number NO of electrodes assigned to the group, the accumulated number Nr of the insufficient currents that will contribute the sparse abnormality is compared with the value:

### N0/P

If the number Nr is smaller than the magnitude of N0/P, the sequence of process-steps proceeds to the step S305 in the step S32 for judging the scattering abnormality. If the number Nr is equal to or larger than the magnitude of N0/P, the group is determined not to be worth of genotyping, because of “large missing data” and judged to be “group abnormal”.

(e) In step S305, whether or not the mean-value of the current values Iₚₖ₂ in the objective data group for judgment is “zero” is estimated. If value of “zero” is estimated, the objective data group for judgment is judged to be “group abnormal” in step S314, and the scattering abnormality of the objective data group is not judged further in step S32. Here, if the sparse abnormality judgment has been carried out prior to the step S305, there must not be the case that the mean-value becomes “zero”. However, if the procedure such that sparse abnormality judgment is not carried out is elected in step S301, there is a case that the objective data group is judged to be “group abnormal”, in step S305. If the mean-value is not “ zero”, the sequence of process-steps proceeds to the next step S306 in the step S32 for judging the scattering abnormality.

(f) In step S306, the mean-value and standard deviation of the current values Iₚₖ₂ in the objective data group for judgment are calculated, and the standard deviation is divided by the mean-value so as to provide the CV value of the objective data group. Then, the sequence of process-steps proceeds to the next step S306.

(g) In step S307, a standard CV value CV0, defined as the setting parameter, is read from the normality-of-group judgment memory 361, and the CV value calculated in step S306 is compared with the standard CV value CV0. If the calculated CV value of the objective data group is smaller than the standard CV value CV0, the objective data group is judged to be normal data group at the next step S308. Moreover, the sequence of process-steps proceeds to the validity-of-test judgment of the step S105 in the flowchart shown in FIG. 14. If the calculated CV value of the objective data group is equal to or greater than the standard CV value CV0, in step S315 in the flowchart in FIG. 24, because of “large scattered data” in the objective data group, the objective data group is judged to be “group abnormal”.

The above-mentioned routines are repeatedly performed on all of the data groups, judging whether or not the data groups are normal, respectively, so that abnormal data group can be eliminated.

The normality-of-group judgement module 320 executes a “group-abnormal judgment”, when a specific data group of the current values Iₚₖ₂ obtained from electrodes is determined as the data out of judgement object, and the display unit 306 displays “error”, and the output unit 305 provide information of the “error” to an external device. Therefore, in the succeeding steps, the calculation can be addressed to the net current value (true current value) Iₚₖ₂. Then, if not otherwise specified, the “net current value Iₚₖ₂” is hereinafter described as a “current value.” Also, only the normal data groups of judgement object are basically addressed and processed in the future calculation, because the data group of sparse abnormality is eliminated.

Step S105: Validity-of-Test Judgement

The detail of the process of the validity-of-test judgement module 325 in step S105 will be described below by using the flowchart shown in FIGS. 29A and 29B. Here, a data group of the current values Iₚₖ₂ respectively measured through the plurality of positive control electrodes 554 and negative control electrodes 555 which are respectively distributed in the plurality of electrode units 761 arranged on the substrate 714 shown in FIG. 4 are judged.

(a) In step S401, at first, whether or not the judgment against the data of negative control is carried out in the validity-of-test judgement is elected. If the judgment against the data of negative control is not carried out, in step S435, the test against the data group of the current values Iₚₖ₂ is judged to be “valid” in the validity-of-test judgment, and the sequence of process-steps in the validity-of-test judgement module 325 is completed. If the judgment against the data of negative control is elected, the sequence of process-steps proceeds to next step S402.

(b) In step S402, if a data group of the current values Iₚₖ₂ respectively obtained from the negative control electrodes 555 has been judged to be “normal” in the preceding normality-of-group judgment in step S104 of the flowchart shown in FIG. 14, the sequence of process-steps proceeds to next step S443. If a data group of the current values Iₚₖ₂ has been judged to be “group abnormal” in the normality-of-group judgment in step S104 of the flowchart shown in FIG. 14, the display unit 306 displays “not determined (N.D.52)”, and the output unit 305 provides information of the “not determined” to an external device in step S441.

(c) In step S443, a mean-value Xₙ and a standard deviation sigmaₙ of the data group of the current values Iₚₖ₂ respectively obtained from the negative control electrodes 555 are calculated, respectively, and stored in the mean-value/standard deviation memory 360.

(d) In step S403, stored negative control upper limit setting parameter NCUL and negative control lower limit setting parameter NCLL are read out from the SLL memory 362, and the mean-value Xₙ of the negative control currents calculated in step S443 is read from the mean-value/standard deviation memory 360. Then, the upper limit setting parameter NCUL, the lower limit setting parameters NCLL, and the mean-value Xₙ of the negative control current values are compared with regard to the magnitude relation. If the mean-value Xₙ of the negative control current values is equal to or greater than the lower limit setting parameters NCLL and equal to or less than the upper limit setting parameter NCUL, in step S404, the negative control is regarded to be reasonable. Then, the sequence of process-steps proceeds to next step S405. If the mean-value Xₙ of the negative control current values lie in the outside of the ranges between the lower limit setting parameters NCLL and the upper limit setting parameter NCUL, in step S421, the negative control is regarded to be abnormal. Then, the sequence of process-steps proceeds to a step S422 (FIG. 23C conceptually shows the case that the mean-value Xₙ of the negative control current values exceeds the upper limit setting parameter NCUL).

(e) In step S405, whether or not the positive control judgment is carried out is elected. If the judgment against the data of positive control is not carried out, in step S412, the validity-of-test judgement module 325 judges the test against the data group of the current values Iₚₖ₂ to be “test valid”, and the sequence of process-steps in the validity-of-test judgement module 325 is completed. When the judgment against the data of positive control will be carried out, the sequence of process-steps proceeds to next step S406.

(f) In step S406, a sequence of process-steps similar to the sequence of process-steps performed on the negative control in step S402 is performed against the data of positive control. In the preceding normality-of-group judgment in step S104 in the flowchart shown in FIG. 14, if the data group of the current values Iₚₖ₂ has been judged to be “normal”, the sequence of process-steps proceeds to next step S444. In the normality-of-group judgment in step S104 in the flowchart shown in FIG. 14, if the data group of the current values Iₚₖ₂ has been judged to be “group abnormal”, the data group of the current values Iₚₖ₂ is treated as “not determined (N.D.51)” in step S442, and the judged results are sorted in the classified-result storing unit 369, and the display unit 306 displays “not determined (N.D.51)”, and the output unit 305 provide information of the “not determined” to an external device.

(g) In step S444, the mean-value Xₚ and standard deviation sigmaₚ of a data group of current values Iₚₖ₂ that are respectively obtained from the positive control electrodes 554 are calculated, respectively, and stored in the mean-value/standard deviation memory 360.

(h) In step S407, the stored positive control lower limit setting parameter PCLL and positive control effective dispersion coefficient PESL are read out from the SLL memory 362, and the mean-value Xₙ and standard deviation sigmaₙ of the negative control currents calculated in step S443 and the mean-value Xₚ and standard deviation sigmaₚ of the positive control currents calculated in step S444 are read out from the mean-value/standard deviation memory 360. The value (Xₚ−Xₙ) in which the mean-value Xₙ of the negative control current values is subtracted from the mean-value Xₚ of the positive control current values is compared with the lower limit setting parameter PCLL, with regard to the magnitude relation. Moreover, the value:

### Xₚ−(PESL*sigmaₚ),

in which the value (PESL*sigma,) of the effective dispersion coefficient PESL multiplied by the standard deviation sigma, of the positive control currents is subtracted from the positive control current value mean-value Xₚ is compared with the value:

### Xₙ+(PESL*sigmaₙ),

in which the value (PESL*sigmaₙ) of the effective dispersion coefficient PESL multiplied by the standard deviation sigmaₙ of the negative control current is added to the mean-value Xₙ of the negative control current values. If the value (Xₚ−Xₙ) in which the mean-value Xₙ of the negative control current values is subtracted from the mean-value Xₚ of the positive control current values is equal to or greater than the lower limit setting parameter PCLL and if the value (Xₚ−(PESL*sigmaₚ)) in which the value (PESL*sigmaₚ) of the effective dispersion coefficient PESL multiplied by the standard deviation sigmaₚ of the positive control currents is subtracted from the positive control current value mean-value Xₚ is equal to or greater than the value (Xₙ +(PESL*sigmaₙ)) in which the value (PESL*sigmaₙ) of the effective dispersion co-efficient PESL multiplied by the standard deviation sigmaₙ of the negative control currents is added to the negative control current value mean-value Xₙ (Step S408), in step S409, the test against the data group of current values Iₚₖ₂ is judged to be “test valid”, and the sequence of process-steps in the validity-of-test judgement module 325 is completed. If any one of them is not satisfied (Step S410), in step S411, the test against the data group of the current values Iₚₖ₂ is judged to be “test invalid”.

(i) In step S403 shown in FIG. 29A, if the mean-value of the negative control current values lie in the outside of the range between the negative control lower limit setting parameter NCLL and the negative control upper limit setting parameter NCUL as shown in FIG. 23C, in step S421 shown in FIG. 29B, the data group of the current values Iₚₖ₂ is judged to be “the negative control abnormal”, and the sequence of process-steps proceeds to the step S422 shown in FIG. 29B. In step S422, similarly to the step S405 shown in FIG. 29A, whether or not the positive control judgment is carried out is elected. If the judgment against the data of positive control is not carried out, in step S434 shown in FIG. 29B, the validity-of-test judgement module 325 judges the test against the data group of the current values Iₚₖ₂ is “test invalid”. Then, the sequence of process-steps in the validity-of-test judgement module 325 is completed. If the judgment against data of positive control will be carried out, the sequence of process-steps proceeds to the next step S423.

(j) In step S423 shown in FIG. 29B, similarly to the process executed in step S406 shown in FIG. 29A, with regard to the positive control, in the preceding normality-of-group judgment in step S104 in the flowchart shown in FIG. 14, if the data group of the current values Iₚₖ₂ has been judged to be “normal”, the sequence of process-steps proceeds to next step S445. In the normality-of-group judgment in step S104 in the flowchart shown in FIG. 14, if the data group of the current values Iₚₖ₂ has been judged to be “group abnormal”, the validity-of-test judgement module 325 judges the test against the data group of the current values Iₚₖ₂ to be “test invalid” in step S431. Then, the sequence of process-steps in the validity-of-test judgement module 325 is completed.

(k) In step S445, the process similar to the step S444 is carried out. That is, the mean-value Xₚ and standard deviation sigmaₚ of the data group of current values Iₚₖ₂, which are respectively obtained from the positive control electrodes 554, are calculated, respectively, and stored in the mean-value/standard deviation memory 360.

(l) In step S424, the stored positive control lower limit setting parameter PCLL and positive control effective dispersion coefficient PESL are read out from the SLL memory 362, and the mean-value Xₙ and standard deviation sigmaₙ of the negative control currents calculated in step S443 and the mean-value Xₙ and standard deviation sigmaₚ of the positive control currents calculated in step S445 are read out from the mean-value/standard deviation memory 360. The value (Xₚ−Xₙ) in which the mean-value Xₙ of the negative control current values is subtracted from the mean-value Xₚ of the positive control current values is compared with the lower limit setting parameter PCLL, with regard to the magnitude relation. Moreover, the value:

Xₚ−(PESL*sigmaₚ),

in which the value (PESL*sigmaₚ) of the effective dispersion coefficient PESL multiplied by the standard deviation sigmaₚ of the positive control currents is subtracted from the positive control current value mean-value Xₚ is compared with the value:

Xₙ+(PESL*sigmaₙ),

in which the value (PESL*sigmaₙ) of the effective dispersion coefficient PESL multiplied by the standard deviation sigmaₙ of the negative control current is added to the mean-value Xₙ of the negative control current values. If the value (Xₚ−Xₙ ) in which the mean-value Xₚ of the negative control current values is subtracted from the mean-value Xₚ of the positive control current values is equal to or greater than the lower limit setting parameter PCLL and if the value (Xₚ−(PESL*sigmaₚ)) in which the value (PESL*sigmaₚ) of the effective dispersion coefficient PESL multiplied by the standard deviation sigmaₚ of the positive control currents is subtracted from the positive control current value mean-value Xₚ is equal to or greater than the value (Xₙ+(PESL*sigmaₙ)) in which the value (PESL*sigmaₙ) of the effective dispersion co-efficient PESL multiplied by the standard deviation sigmaₙ of the negative control currents is added to the negative control current value mean-value Xₙ, (step S425), in step S426, the test against the data group of the current values Iₚₖ₂ is judged to be “test invalid”, and the sequence of process-steps in the validity-of-test judgement module 325 is completed. In step S424, if any one of the above-mentioned conditions is not satisfied (step S432), in step S433, the test against the data group of the current values Iₚₖ₂ is judged to be “test invalid”, and this process is completed.

Step S106: Two Genotyping Algorithms

In step S106 of FIG. 14, as shown in FIG. 25A, in the validity-of-test judgement in step S332, if the test against the data group of the current values Iₚₖ₂ is judged to be valid, the sequence of process-steps proceeds to the step S333, and the selection between two genotyping algorithms is carried out. In the validity-of-test judgement in step S332, if the test against the data group of the current values Iₚₖ₂ is judged to be invalid, the display unit 306 displays “test invalid” in step S334, and the judged results are sorted and stored in the classified-result storing unit 369. Furthermore, the output unit 305 transfers information of the “test invalid” to an external device, and the signal process is completed.

In step S333, whether the sequence of process-steps proceeds to:

(a) a flow of presence judgment algorism for determining whether or not there is a certain nucleic acid, or

(b) a flow of SNP type judgment algorism for judging whether the SNP type is wild homo type, hetero type or mutant homo type, namely, for example, G/G homo type, G/T hetero type, T/T homo type or the like, is determined.

Step S106-1: Presence Determination Of Nucleic Acid

In step S333 of FIG. 25A, when it is decided to employ the flow of genotyping algorithm for determining the presence of a certain nucleic acid, the presence judgement module 330 determines according to the procedure of the flowchart shown in FIG. 25B.

FIG. 2 shows the electrode unit in which the SNP1 detecting electrodes 551, the SNP2 detecting electrodes 552, the control electrodes 553, the reference electrodes 561, 562 and the opposite electrode 502 are arranged on the detection chip. However, in the case of the algorism for judging whether or not there is a certain nucleic acid, any one of the SNP1 detecting electrodes 551 and the SNP2 detecting electrodes 552 may be arranged. That is, on the substrate 714 shown in FIG. 4, the plurality of electrode units 761, on which either one of the set of SNP1 detecting electrodes 551 and the set of SNP2 detecting electrodes 552 are distributed as the detecting electrode (active electrode). Here, the description is carried out under the assumption that the set of SNP1 detecting electrodes 551 shown in FIG. 2 are the set of active electrodes for detecting the target nucleic acid, respectively.

(a) In step S341 in the flowchart shown in FIG. 25B, the presence judgement module 330 judges whether or not the data group of the current values Iₚₖ₂ respectively obtained from the control electrodes 553 is “group normal” as the result of the process in the normality-of-group judgement module 320. In step S341, if the data group of the current values Iₚₖ₂ is judged to be “group normal”, the sequence of process-steps proceeds to the next step S342. As the result of the process in the normality-of-group judgement module 320, if the data group of the current values Iₚₖ₂ is judged to be “group abnormal”, the data group is treated as “not determined (N.D.21)”, the judged results are sorted and stored in the classified-result storing unit 369. In step S348, the display unit 306 displays “not determined (N.D.21)”, and the output unit 305 provides information of the “not determined” to an external device.

(b) Moreover, in step S342, the presence judgement module 330 judges whether or not the data group of the current values Iₚₖ₂ respectively measured through the plurality of presence-detecting electrodes (active electrodes) 551 targeted for the judgment is “group normal”, as the result of the process in the normality-of-group judgement module 320. In step S342, if the data group is judged to be “group normal”, the sequence of process-steps proceeds to the next step S343. As the result of the process in the normality-of-group judgement module 320, if the data group is judged to be “group abnormal”, the data group is treated as “not determined (N.D.22)”, and the judged results are sorted and stored in the classified-result storing unit 369. Then, the display unit 306 displays “not determined (N.D.22)”, and the output unit 305 provides information of the “not determined” to an external device in step S349.

(c) Next, the mean-value (X) and standard deviation (sigma) of the objective current values obtained through the plurality of presence-detecting electrodes (active electrodes) 551 targeted for the judgment in step S343 and the mean-value (X_{c}) and standard deviation (sigma_{c}) of the current values obtained through the corresponding control electrode 553 are calculated and then stored in the mean-value/standard deviation memory 360.

(d) In step S344, the presence judgement module 330 reads the mean-value (X) of the current values obtained through the presence-detecting electrodes (active electrodes) 551 and the mean-value (X_{c}) of the current values obtained through the corresponding control electrode 553, from the mean-value/standard deviation memory 360 and calculates the difference (X−X_{c}) between the mean-values X and X_{c}. Moreover, an upper signal increment criterion SL (−) for “−” judgment is read out from the SLL memory 362. Then, in step S344, the magnitude of the difference (X−Xc) between the mean-values X and X_{c} is compared with the magnitude of the upper signal increment criterion SL (−). In step S344, if the magnitude of the difference (X−Xc) is judged to be equal to or smaller than the upper signal increment criterion SL (−), the current value of the electrochemical current of the target nucleic acid is judged as not being obtained from the presence-detecting electrodes (active electrodes) 551, and the judged results are sorted and stored in the classified-result storing unit 369. Then, in step S344, the judgment of “−(less than detection sensitivity)” is displayed on the display unit 306. On the other hand, in step S344, if the magnitude of the difference (X−Xc) is larger than the upper signal increment criterion SL (−), the sequence of process-steps proceeds to the step S345.

(e) In step S345, the presence judgement module 330 reads out the mean-value (X) of the current values obtained through the presence-detecting electrodes (active electrodes) 551 and the mean-value (X_{c}) of the current values obtained through the corresponding control electrode 553, from the mean-value/standard deviation memory 360 and calculates the difference (X−X_{c}) between the mean-values X and X_{c}. Moreover, a lower signal increment criterion SL (+) for “+” judgment is read out from the SLL memory 362. Then, the magnitude of the difference (X−X_{c}) between the mean-values X and X_{c} is compared with the magnitude of the lower signal increment criterion SL (+). In step S345, if the magnitude of the difference (X−X_{c}) is judged to be smaller than the lower signal increment criterion SL (+), the data group of the current values Iₚₖ₂ is treated as “not determined (N.D.01)”, and the judged results are sorted and stored in the classified-result storing unit 369. Then, in step S351, the display unit 306 displays “not determined (N.D.01)”, and the output unit 305 provides information of the “not determined” to an external device. As shown in FIG. 30, the decision of “not determined (N.D.01)” represents that the data group of the current values Iₚₖ₂ is lie in a halfway between the upper signal increment criterion SL (−) and the lower signal increment criterion SL (+), indicating that the increment of the electrochemical signal obtained through the presence-detecting electrodes (active electrodes) 551, the increment is the difference between the electrochemical signals obtained through the control electrodes and the electrochemical signal obtained through the presence-detecting electrodes (active electrodes) 551, is not sufficiently large to decide the “+” judgment and is not sufficiently small to decide the “−” judgment, and represents the situation that the +/− judgment cannot be decided. On the other hand, in step S345, if the magnitude of the difference (X−X_{c}) is equal to or larger than the lower signal increment criterion SL (+), the sequence of process-steps proceeds to the step S346.

(f) In step S346, the presence judgement module 330 reads out the mean-value (X) and standard deviation (sigma) of the current values obtained through the presence-detecting electrodes (active electrodes) 551, and the mean-value (X_{c}) and standard deviation (sigma_{c}) of the current values obtained through the corresponding control electrode 553, from the mean-value/standard deviation memory 360, and further reads out the effective dispersion coefficient ESLL from the SLL memory 362. The magnitude of a value:

### X−ESLL*sigma,

which is the value smaller than the mean-value X of the currents from the presence-detecting electrodes 551 by the product of the effective dispersion coefficient ESLL and the standard deviation sigma is compared with the magnitude of a value:

### X_{c}+ESLL*sigma_{c},

which is the value larger than the mean-value X_{c} of the currents from the control electrode by the product of the effective dispersion coefficient ESLL and the standard deviation sigma_{c}. If the magnitude of the value of (X−ESLL*sigma) is equal to or larger than the magnitude of (X_{c}+ESLL*sigma_{c}), namely, if the inequality (5) of:

X−ESLL*sigma>=X_{c}+ESLL*sigma_{c} (5)

is established, a sufficient signal increment is considered to be obtained, and the “+” judgment is carried out. Then, the judged results are sorted and stored in the classified-result storing unit 369. Then, in step S347, “+” is outputted to the display unit 306 and the output unit 305. On the other hand, if the inequality (5) is not satisfied, the signal increment is judged not to be sufficiently large against the dispersion of signal. Then, it is treated as “not determined (N.D.02)”, and the judged results are sorted and stored in the classified-result storing unit 369. In step S352, the display unit 306 displays “not determined (N.D.02)”, and the output unit 305 provides information of the “not determined” to an external device.

That is, in step S345, even if the difference (X−Xc) between the mean-values X and Xc is equal to or larger than the lower signal increment criterion SL (+), “+” is not immediately displayed. So, in step S346, whether or not the current increment is sufficiently larger than the dispersion is judged. Here, as for the lower signal increment criterion SL (+) and the upper signal increment criterion SL (−) shown in FIG. 30, it is preferred to measure a plurality of samples and calculate the signal increment in accordance with the above-mentioned procedure and then calculate and determine the values of the lower signal increment criterion SL (+) and the upper signal increment criterion SL (−), for the “+” samples and the “−” samples, respectively, from the respective statistical values. Preferably, they are preferred to be determined from the mean-value and standard deviation of the signal increments of each of the “+” sample and the “−” sample. Further preferably, the lower signal increment criterion SL (+) is determined to be “mean value−3*(standard deviation)” for the “+” sample, and the upper signal increment criterion SL (−) is determined to be “mean value+3*(standard deviation)” for the “−” sample. By the way, the numbers of the samples used to determine the lower signal increment criterion SL (+) and the upper signal increment criterion SL (−) are desired to be 30 samples or more, respectively.

Step S106-2: Determination of SNP Type

In step S333 of FIG. 25A, if it is determined to proceed to the flow of the genotyping algorithm for determining whether the SNP type is wild homo type, hetero type or mutant homo type, the typing module 340 carries out a determination process, in accordance with the procedure of the flowchart shown in FIG. 25C. By the way, here, the description is carried out under the assumption that SNP=“G” is detected in the SNP1 detecting electrodes 551 and that SNP=“T” is detected in the SNP2 detecting electrodes 552. Also, the description is carried out under the assumption that the probe DNAs for detecting the wild type SNP are immobilized to the SNP1 detecting electrodes 551, and the probe DNAs for detecting the mutant type SNP are immobilized to the SNP2 detecting electrodes 552. Of course, there is no problem in the case that the SNP1 detecting electrodes are designed to detect the mutant type SNP, and the SNP2 detecting electrodes are designed to detect the wild type SNP. However, care should be paid to the magnitude relation between the judgment standard parameters.

Hereafter, the procedure in which the typing module 340 determines whether, as for the sample DNAs, for example, the base of a certain SNP position is G/G homo type or G/T hetero type or T/T homo type is described in accordance with the flowchart shown in FIG. 25C.

(a) At first, the typing module 340 determines whether or not the number of the targets is two pieces, in step S361. In this case, because it intends to determine between the two types of SNP=“G” and SNP=“T”, if the number of the targets is zero, a single piece, three pieces, or the like, the initial setting itself is wrong. Thus, the judged results are sorted and stored in the classified-result storing unit 369. Then, in step S381, the display unit 306 displays “setting error”, and the output unit 305 provides information of the “setting error” to an external device.

(b) In step S361, if the number of the targets is determined to be two pieces, the typing module 340 proceeds to the step S362. In step S362, the typing module 340 makes the sequence of process-steps proceeds to the next step S363, if the current values obtained through the control electrodes (C1) 553 corresponding to the SNP1 detecting electrodes 551 and the control electrode (C2) 553 corresponding to the SNP2 detecting electrodes 552 are both determined to be “group normal”, as the result of the process in the normality-of-group judgement module 320 (FIG. 2 shows the common control electrodes 553 corresponding to both the SNP1 detecting electrodes 551 and the SNP2 detecting electrodes 552. However, it is possible to set a control electrodes (NC1) corresponding to the SNP1 detecting electrodes 551 and a control (NC2) corresponding to the SNP2 detecting electrodes 552 separately.). As the result of the process in the normality-of-group judgement module 320, if any one of the current values obtained through the control electrodes C1 and C2 are determined to be “group abnormal”, the current values are treated as “not determined (N.D.31)”. Then, the judged results are sorted and stored in the classified-result storing unit 369, and in step S382, the display unit 306 displays “not determined (N.D.31)”, and the output unit 305 provides information of the “not determined” to an external device.

(c) Moreover, in step S363, the typing module 340 proceeds to the next step S364, if the current values obtained through the SNP1 detecting electrodes 551 and the SNP2 detecting electrodes 552 that are targeted for the judgment are both determined to be “group normal”, as the result of the process in the normality-of-group judgement module 320. As the result of the process in the normality-of-group judgement module 320, if any one of the current values obtained through the SNP1 detecting electrodes 551 and the SNP2 detecting electrodes 552 are determined to be “group abnormal”, the current values are treated as “not determined (N.D.32)”, and the judged results are sorted and stored in the classified-result storing unit 369. Then, in step S383, the display unit 306 displays “not determined (N.D.32)”, and the output unit 305 provides information of the “not determined” to an external device.

(d) Next, in step S364. the typing module 340 calculates:

a mean-value X, calculated from the current values measured through the plurality of SNP1 detecting electrode (SNP=“G” detecting electrode) 551;

a mean-value X_{c1} calculated from the current values measured through the control electrodes (C1) 553 corresponding to the SNP1 detecting electrodes 551;

a mean-value X₁ calculated from the current values measured through the plurality of SNP2 detecting electrode (SNP=“T” detecting electrode) 552; and

a mean-value X_{c2} calculated from the current values measured through the plurality of control (C2) electrode 556 corresponding to the SNP2 detecting electrodes 552.

The calculated mean-value X₁ obtained from the current values measured the SNP1 detecting electrodes 551, the calculated mean-value X_{c1} obtained from the current values measured the control electrodes (C1) 553 corresponding to the SNP1 detecting electrodes 551, the calculated mean-value X₂ obtained from the current values measured the SNP2 detecting electrodes 552, and the calculated mean-value X_{c2} obtained from the current values measured the plurality of control (C2) electrode 556 corresponding to the SNP2 detecting electrodes 552 are stored in the mean-value/standard deviation memory 360.

(e) Next, in step S365, the typing module 340 reads out the mean-value X₁ obtained from the current values measured the SNP1 detecting electrodes 551 and the mean-value X_{cl} obtained from the current values measured the plurality of corresponding control electrodes (C1) 553, from the mean-value/standard deviation memory 360, and calculates a value Z₁ (normalized SNP1 current increment) in which the difference (X₁−X_{c1}) between the mean-value X₁ obtained from the current values measured the SNP1 detecting electrodes 551 and the mean-value X_{c1} obtained from the current values measured the control electrodes (C1) 553 is divided by the mean-value X_{c1} obtained from the current values measured the control electrodes (C1) 553:

Z₁=(X₁−X_{c1})/X_{c1} (6)

Similarly, the typing module 340 reads out the mean-value X₂ obtained from the current values measured the SNP2 detecting electrodes 552 and the mean-value X_{c2} obtained from the current values measured the plurality of corresponding control electrode (C2) 554, from the mean-value/standard deviation memory 360, and calculates a value Z₂ (normalized SNP2 current increment) in which the difference (X₂−X_{c2}) between the mean-value X₂ obtained from the current values measured the SNP2 detecting electrodes 552 and the mean-value X_{c2} obtained from the current values measured the control electrodes (C2) 556 is divided by the mean-value X_{c2} obtained from the current values measured the control electrodes (C2) 556:

Z₂=(X₂−X_{c2})/X_{c2} (7)

Then, the calculated Z₁ and Z₂ are stored in the normalized coordinate memory 365, and the sequence of process-steps proceeds to the step S366.

(f) In step S366, the typing module 340 reads out the normalized SNP1 current increment Z₁ and the normalized SNP2 current increment Z₂, from the normalized co-ordinate memory 365. In step S366, moreover, if the normalized SNP1 current increment Z₁ and the normalized SNP2 current increment Z₂ are both “negative”, the data calculated from the current values measured through both of the SNP1 detecting electrodes 551 and the SNP2 detecting electrodes 552 cannot establish the current increase. Thus, the subject current values are treated as “not determined (N.D.16)”, and the judged results are sorted and stored in the classified-result storing unit 369. Then, in step S384, the display unit 306 displays “not determined (N.D.16)”, and the output unit 305 provides information of the “not determined” to an external device. If any one of the normalized SNP1 current increment Z₁ and the normalized SNP2 current increment Z₂ is ^{“}equal to or larger than zero”, the sequence of process-steps proceeds to the next step S367.

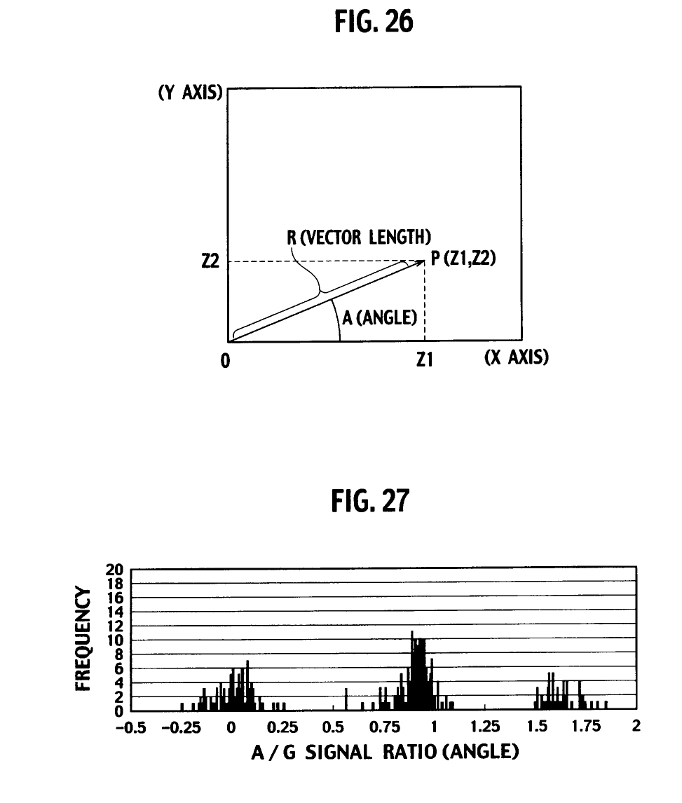

(g) In step S367, the typing module 340 reads out the normalized SNP1 current increment Z₁ and the normalized SNP2 current increment Z₂, from the normalized co-ordinate memory 365. In step S367, moreover, the coordinates (Z₁, Z₂) of a point, at which the normalized SNP1 current increment Z₁ is defined along an X-coordinate and the normalized SNP2 current increment Z₁ is defined along a Y-coordinate, is converted into polar coordinates (R, A). That is, as shown in FIG. 26, for the point P manifested by the X-coordinate Z, and the Y-coordinate Z₂, “R” indicates the distance (vector length) of the vector between origin and the point P (Z₁, Z₂), and “A” indicates the angle between the positive X-axis and the vector from origin to the point P (Z₁, Z₂). Here, in step S366, if both of the X-coordinate (Z₁) and the Y-coordinate (Z₂) are negative, the data calculated from the current values measured through both of the SNP1 detecting electrodes 551 and the SNP2 detecting electrodes 552 is eliminated as the disable judgment. Thus, the angle “A” has the value between −pi/2 and pi. Then, the vector length “R” calculated in step S367 is stored in the vector length memory 366, and the angle “A” is stored in the angle memory 367, respectively, and the sequence of process-steps proceeds to the step S368.

(h) In step S368, the typing module 340 reads out the vector length “R” calculated in step S367, from the vector length memory 366. Moreover, the typing module 340 reads out a current-increment-rate criterion MIR from an MIR memory 364 and compares the vector length “R” and the current-increment-rate criterion MIR, with regard to the magnitude relation (The current-increment-rate criterion MIR is the setting parameter to give the lower limit of the current-increment-rate). If the vector length “R” is smaller than the current-increment-rate criterion MIR, the current increment is determined to be excessively small. Then, the data calculated from the current values measured through both of the SNP1 detecting electrodes 551 and the SNP2 detecting electrodes 552 is identified as “not determined (N.D.15)”, and the judged results are sorted and stored in the classified-result storing unit 369. In step S385, the display unit 306 displays “not determined (N.D.15)”, and the output unit 305 provides information of the “not determined” to an external device. If the vector length “R” is equal to or larger than the current-increment-rate criterion MIR, the sequence of process-steps proceeds to the next step S369. On and after the step S369, whether the SNP type of the judgment object is wild homo type, hetero type or mutant homo type is determined. Here, recall that the description is carried out under the assumption that the probe DNAs for detecting the wild type SNP are immobilized at the SNP1 detecting electrode, and the probe DNAs for detecting the mutant type SNP are immobilized at the SNP2 detecting electrode.

(i) The typing module 340 reads out the angle “A” calculated in step S367 from the angle memory 367, and reads out a wild type lower limit angle Wₘᵢₙ from the angular parameter memory 368, and then compares the magnitude relation in step S370. If the angle “A” is smaller than the wild type lower limit angle Wₘᵢₙ, the data calculated from the current values measured through both of the SNP1 detecting electrodes 551 and the SNP2 detecting electrodes 552 is identified as “not determined (N.D.11)”, and the judged results are sorted and stored in the classified-result storing unit 369. Then, in step S391, the display unit 306 displays “not determined (N.D.11)”, and the output unit 305 provides information of the “not determined” to an external device. If the angle “A” is equal to or larger than the wild type lower limit angle Wₘᵢₙ, the sequence of process-steps proceeds to the next step S370.

(j) The typing module 340 reads out the angle “A” calculated in step S367 from the angle memory 367, and reads out the wild type lower limit angle Wₘᵢₙ and a wild type upper limit angle Wₘₐₓ from the angular parameter memory 368, and then compares the magnitude relation in step S370. If the angle “A” is between the wild type lower limit angle Wₘᵢₙ and the wild type upper limit angle Wₘₐₓ, the data calculated from the current values measured through both of the SNP1 detecting electrodes 551 and the SNP2 detecting electrodes 552 is identified as “SNP1 type” (here, G/G homo type, namely wild homo type), and the judged results are sorted and stored in the classified-result storing unit 369. Then, in step S392, the display unit 306 displays “G/G type”, and the output unit 305 provides information of the “G/G type” to an external device. If the angle “A” is larger than the wild type upper limit angle Wₘₐₓ, the sequence of process-steps proceeds to the next step S371.

(k) The typing module 340 reads out the angle “A” calculated in step S367 from the angle memory 367 and reads out the wild type upper limit angle Wₘₐₓ, and a hetero type lower limit angle Hₘᵢₙ from the angular parameter memory 368, and compares the magnitude relation, in step S371. If the angle “A” is larger than the wild type upper limit angle Wₘₐₓ and smaller than hetero type lower limit angle Hₘᵢₙ, the data calculated from the current values measured through both of the SNP1 detecting electrodes 551 and the SNP2 detecting electrodes 552 is identified as “not determined (N.D.12)”, and the judged results are sorted and stored in the classified-result storing unit 369. Then, in step S393, the display unit 306 displays “not determined (N.D.12)”, and the output unit 305 provides information of the “not determined” to an external device. If the angle “A” is equal to or larger than hetero type lower limit angle Hₘᵢₙ, the sequence of process-steps proceeds to the next step S372.

(l) The typing module 340 reads out the angle “A” calculated in step S367 from the angle memory 367, and reads out hetero type lower limit angle Hₘᵢₙ and a hetero type upper limit angle Hₘₐₓ from the angular parameter memory 368, and then compares the magnitude relation, in step S372. If the angle “A” is between hetero type lower limit angle Hₘᵢₙ and hetero type upper limit angle Hₘₐₓ, the data calculated from the current values measured through both of the SNP1 detecting electrodes 551 and the SNP2 detecting electrodes 552 is identified as “SNP1/SNP2 type” (here, G/T hetero type, namely, hetero type), and the judged results are sorted and stored in the classified-result storing unit 369. Then, in step S394, the display unit 306 displays “G/T type”, and the output unit 305 provides information of the “G/T type” to an external device. If the angle “A” is larger than hetero type upper limit angle Hₘₐₓ, the sequence of process-steps proceeds to the next step S373.

(m) The typing module 340 reads out the angle “A” calculated in step S367 from the angle memory 367, and reads out hetero type upper limit angle Hₘₐₓ and a mutant type lower limit angle Mₘᵢₙ from the angular parameter memory 368, and then compares the magnitude relation, in step S373. If the angle “A” is larger than hetero type upper limit angle and smaller than the mutant type lower limit angle Mₘᵢₙ, the data calculated from the current values measured through both of the SNP1 detecting electrodes 551 and the SNP2 detecting electrodes 552 is identified as “not determined (N.D.13)”, and judgment results are sorted and stored in the classified-result storing unit 369. Then, in step S395, the display unit 306 displays “not determined (N.D.13)”, and the output unit 305 provides information of the “not determined” to an external device. If the angle “A” is equal to or larger than the mutant type lower limit angle M_{min,} the sequence of process-steps proceeds to the next step S374.

(n) The typing module 340 reads out the angle “A” calculated in step S367 from the angle memory 367, and reads out the mutant type lower limit angle Mₘᵢₙ and a mutant type upper limit angle Mₘₐₓ from the angular parameter memory 368, and then compares the magnitude relation, in step S374. If the angle “A” is between the mutant type lower limit angle Mₘᵢₙ and the mutant type upper limit angle Mₘₐₓ, the data calculated from the current values measured through both of the SNP1 detecting electrodes 551 and the SNP2 detecting electrodes 552 is identified as “SNP2 Type (here, T/T homo type, namely, mutant homo type”, and judgment results are sorted and stored in the classified-result storing unit 369. Then, in step S396, the display unit 306 displays “T/T type”, and the output unit 305 provides information of the “T/T type” to an external device. If the angle “A” is larger than the mutant type upper limit angle Mₘₐₓ, the sequence of process-steps proceeds to the next step S375.

(o) The typing module 340 reads out the angle “A” calculated in step S367 from the angle memory 367, and reads out the mutant type upper limit angle Mₘₐₓ from the angular parameter memory 368, and then compares the magnitude relation, in step S375. If the angle “A” is larger than the mutant type upper limit angle Mₘᵢₙ, the data calculated from the current values measured through both of the SNP1 detecting electrodes 551 and the SNP2 detecting electrodes 552 is identified as “not determined (N.D.14)”, and the judged results are sorted and stored in the classified-result storing unit 369. Then, in step S397, the display unit 306 displays “not determined (N.D.14)”, and the output unit 305 provides information of the “not determined” to an external device. By the way, the magnitude relation comparison between the angle “A” and the mutant type upper limit angle Mₘₐₓ in step S375 is not always required. When the sequence of process-steps has been proceeded to the step S375, the data calculated from the current values measured through both of the SNP1 detecting electrodes 551 and the SNP2 detecting electrodes 552 may be treated as “not determined (N.D.14)” without any condition.

Here, the angle judgment criteria, namely, the wild type lower limit angle Wₘᵢₙ, the wild type upper limit angle Wₘₐₓ, hetero type lower limit angle Hₘᵢₙ, hetero type upper limit angle Hₘₐₓ, the mutant type lower limit angle Mₘᵢₙ and the mutant type upper limit angle Mₘₐₓ are measured, with regard to the plurality of samples. Then, the angle between the positive X-axis and the vector from origin to the point (Z₁, Z₂), the normalized SNP1 current increment Z₁ is defined along an X-coordinate and the normalized SNP2 current increment Z₂ is defined along a Y-coordinate, is calculated, and the angle judgment criteria are preferred to be determined by the calculation from the statistical values of the respective types (the wild type, hetero type and the mutant type). Preferably, the angle judgment criteria are preferred to be determined in accordance with the mean-value and standard deviation of the angles calculated for each type. Further preferably, “mean value −3*(standard deviation)” is defined as the lower limit angle, and “mean value +3*(standard deviation)” is defined as the upper limit angle. By the way, the number of the samples used to determine the angle judgment criteria is desired to be 30 samples or more for each type.

Also, the current-increment-rate criterion MIR is similarly preferred to be determined by the statistical calculation from the data with regard to the plurality of samples. Also, the current-increment-rate criterion MIR is preferred to be determined by using the mean-value and standard deviation of the vector lengths determined in accordance with the measurement for the plurality of samples, similarly to the angle judgment criteria. The current-increment-rate criterion MIR is further preferred to be defined as “mean value −3*(standard deviation)”. By the way, the number of the samples used to determine the current-increment-rate criterion MIR is desired to be 30 samples or more.

The type judging procedure in the typing module 340 can be easily understood from FIG. 28. Although details of the genotyping algorithm for identifying the SNP type is as mentioned above, in a schematic view point, if the angle “A” lies in a range of the wild type angle judgment criterion (a range between wild type lower limit angle Wₘᵢₙ and wild type upper limit angle Wₘₐₓ), the subject data calculated from the current values is identified as “wild type”, and if the angle “A” lies in a range of the hetero type angle judgment criterion (a range between hetero type lower limit angle Hₘᵢₙ and hetero type upper limit angle Hₘₐₓ), the subject data calculated from the current values is identified as “hetero type”, and if the angle “A” lies in a range of the mutant type angle judgment criterion (a range between mutant type lower limit angle Mₘᵢₙ and mutant type upper limit angle Mₘₐₓ), the subject data calculated from the current values is identified as “mutant type”.

Vice versa, when the first probe nucleic acids are probe DNAs configured to detect a genotype of mutant type, and the second probe nucleic acids are probe DNAs configured to detect a genotype of wild type, the angle judgment criteria includes a mutant type lower limit angle Mₘᵢₙ defined by an angle from the positive X-axis; a mutant type upper limit angle Mₘₐₓ defined by an angle from the positive X-axis larger than the wild type lower limit angle; a hetero type lower limit angle Hₘᵢₙ having an angle larger than the wild type upper limit angle; a hetero type upper limit angle Hₘₐₓ having an angle larger than the hetero type lower limit angle; a wild type lower limit angle Wₘᵢₙ having an angle larger than the hetero type upper limit angle; and a wild type upper limit angle Wₘₐₓ having an angle larger than the mutant type lower limit angle, although not shown in the Drawings.

Also, FIG. 27 shows the frequency distribution of the data calculated from the current values when the present genotyping algorithm is applied to serum amyloid A (SAA) 1 gene polymorphisms, and abscissa indicates the angle “A” in the unit of radian, which represents A/G signal ratio. As shown in FIG. 27, the frequency distribution is separated as wild homo type, hetero type and the mutant homo type as angle increases from the left along abscissa. FIG. 27 proves that the angle judgment criteria can be set such that the wild type lower limit angle Wₘᵢₙ is −0.28 radian, the wild type upper limit angle Wₘₐₓ is 0.28 radian, hetero type lower limit angle Hₘᵢₙ is 0.74 radian, hetero type upper limit angle Hₘₐₓ is 1.09 radian, the mutant type lower limit angle Mₘᵢₙ is 1.39 radian, and the mutant type upper limit angle Mₘₐₓ is 1.85 radian.

As understood from above-mentioned explanation, according to the nucleotide sequence method associated with the embodiment of the present invention, even when there are abnormalities in the chip cartridge 11 and the detecting system 12, and when there is dispersion in data, it can be determined with high accuracy if a certain nucleic acid is present by excluding such abnormal data. In addition, according to the nucleotide sequence method associated with the embodiment of the present invention, if the initial setting has an error, it is determined to be a “setting error.” If the chip or the sample (biological sample) has an abnormality, it is determined to be “not determined (bio sample error).” If there is a device (hardware) failure, these abnormal data can be eliminated by processing, such as determining as “not determined (hardware error).” The foregoing processes enable the elimination of abnormal data. Moreover, even in the case that the dispersion in the signal disables the judgment or in the case that the signal magnitude is weak, the judgment corresponding to the working situation can be attained. For this reason, according to the nucleotide sequence determination method associated with the embodiment of the present invention, in suitable response to the various measurement environments or situations (actual conditions), at the high precision, it is possible to identify the type to which the SNP type belongs, such as “wild homo type”, “mutant homo type”, “hetero type” and the like, or judge whether it is the homo type or hetero type. Here, the types represented by “wild type”, “hetero type” and “mutant type” may be recited by using the specific base names, such as “A”, “T”, “G”, “C” and the like.

(Nucleotide Sequence Determination Program)

The sequences of determination operations shown in FIG. 14, FIG. 16, FIGS. 18A-18B, FIG. 24, FIGS. 25A-25C, and FIGS. 29A-25B, by the program for genotyping algorithm equivalent to the FIG. 14, FIG. 16, FIGS. 18A-18B, FIG. 24, FIGS. 25A-25C, and FIGS. 29A-25B, the nucleotide sequence determination system shown in FIG. 8 can be controlled and executed. The program may be stored in the program memory (not shown) of a computer system that implements the nucleotide sequence determination system of the present invention. In addition, the program can perform a sequence of determination operations of the present invention. Wherein, “computer-readable recording medium” means a medium that can record programs, such as a computer external memory, semiconductor memory, magnetic disk, optical disk, magnet-optical (MO) disk, magnetic tape, and the like. More particularly, the “computer readable recording medium” contains a flexible disk, compact disk (CD)-read-only memory (ROM), cassette tape, open reel tape, memory card, hard disk, removable disk, and the like.

For example, the main body of the nucleotide sequence determination system can be implemented by a flexible disk drive and a optical disk drive or to externally connect with them. A flexible disk for the flexible disk drive and a CD-ROM for the optical disk drive are inserted from the insertion port. By performing a specific read-out operation, the program stored in these recording mediums can be installed in the program memory that implements the nucleotide sequence determination system. In addition, by connecting a specific drive unit, it is possible to use ROM as a memory that has been utilized for a game pack and the like or a cassette tape as a magnetic tape device. Furthermore, via an information-processing network including the internet and the like, the program can be stored in the program memory.

### OTHER EMBODIMENTS

Various modifications will become possible for those skilled in the art after receiving the teaching of the present disclosure without departing from the scope thereof.

The above-mentioned descriptions of the embodiment are procedures for determining one type among G type, T type, or G/T type. However, it is may be applied to the determination of two types among them or the determination of whether they are hetero of the two types. In addition, as understood by descriptions of above-mentioned embodiment, it is not necessary to acquire the measurement data for four types of A type, G type, C type, and T type groups. Obtaining only two groups for two possible bases of SNP may be sufficient.

Thus, the present invention of course includes various embodiments and modifications and the like which are not detailed above. Therefore, the scope of the present invention will be defined in the following claims.

### INDUSTRIAL APPLICABILITY

The present invention can be applied to a wide range of molecular biological engineering directed to disease-related genes, analysis of the individual differences in drug metabolism, and chronic diseases. Especially the present invention can be practically applied to nucleic acid hybridization.

1. A method for determining nucleotide sequence comprising:
injecting a solution containing a sample nucleic acid into a chip cartridge, which is provided with a plurality of first detecting electrodes to which first probe nucleic acids are respectively immobilized, a plurality of second detecting electrodes to which second probe nucleic acids having different nucleotide sequences from the first probe nucleic acids are respectively immobilized, and a plurality of control electrodes to which control nucleic acids having different nucleotide sequences from the first and second probe nucleic acids are respectively immobilized;
detecting first detection signals through the first detecting electrodes, second detection signals through the second detecting electrodes, and control signals through the control electrodes, respectively;
calculating a value of a first difference obtained by subtracting the mean value of the control signals from a mean value of the first detection signals, and dividing the value of the first difference by the mean value of the control signals so as to define a value of X-coordinate;
calculating a value of a second difference obtained by subtracting a mean value of the control signals from a mean value of the second detection signals, and dividing the value of the second difference by the mean value of the control signals so as to define a value of Y-coordinate;
calculating an angle between a positive X-axis and a vector from origin to a point which is defined by the X-coordinate and the Y-coordinate; and
comparing the angle with angle judgment criteria so as to identify a genotype of the sample nucleic acid, in accordance with a magnitude relation between the angle and the angle judgment standard.

2. The method of claim 1, further comprising:
obtaining slopes of tail lines in each of the current-voltage characteristic curves established by the first detection signals, the second detection signals and the control signals; and
assigning normality or abnormality of the current-voltage characteristics curve from the slopes of the tail lines, and to exclude abnormal detection signals from calculation object, before calculating the value of the first and second differences.

3. The method of claim 2, further comprising:
subtracting a corresponding baseline current value defined in the current-voltage characteristic curves established by the first detection signals, the second detection signals, and the control signals from corresponding peak currents in the current-voltage characteristic curves established by the first detection signals, the second detection signals, and the control signals, respectively; and
obtaining net currents for the first detection signals, the second detection signals, and the control signals, before calculating the value of the first and second differences.

4. The method of claim 3, further comprising:
determining a normal data group and an abnormal data group, from a plurality of data groups consisting of the net currents so as to eliminate the abnormal data group, before calculating the value of the first and second differences.

5. The method of claim 1, wherein, when the first probe nucleic acids are probe DNAs configured to detect a genotype of wild type, and the second probe nucleic acids are probe DNAs configured to detect a genotype of mutant type, the angle judgment criteria includes:
a wild type lower limit angle defined by an angle from the positive X-axis;
a wild type upper limit angle defined by an angle from the positive X-axis larger than the wild type lower limit angle;
a hetero type lower limit angle having an angle larger than the wild type upper limit angle;
a hetero type upper limit angle having an angle larger than the hetero type lower limit angle;
a mutant type lower limit angle having an angle larger than the hetero type upper limit angle; and
a mutant type upper limit angle having an angle larger than the mutant type lower limit angle;
wherein, when the first probe nucleic acids are probe DNAs configured to detect a genotype of mutant type, and the second probe nucleic acids are probe DNAs configured to detect a genotype of wild type, the angle judgment criteria includes:
a mutant type lower limit angle defined by an angle from the positive X-axis;
a mutant type upper limit angle defined by an angle from the positive X-axis larger than the wild type lower limit angle;
a hetero type lower limit angle having an angle larger than the wild type upper limit angle;
a hetero type upper limit angle having an angle larger than the hetero type lower limit angle;
a wild type lower limit angle having an angle larger than the hetero type upper limit angle; and
a wild type upper limit angle having an angle larger than the mutant type lower limit angle.

6. The method of claim 5, wherein the sample nucleic acid is identified as wild type when the angle derived from the sample lies in an area between the wild type lower limit angle and the wild type upper limit angle.

7. The method of claim 5, wherein the sample nucleic acid is identified as hetero type when the angle derived from the sample lies in an area between the hetero type lower limit angle and the hetero type upper limit angle.

8. The method of claim 5, wherein the sample nucleic acid is identified as mutant type when the angle derived from the sample lies in an area between the mutant type lower limit angle and the mutant type upper limit angle.

9. The method of claim 1, wherein a genotype of the sample nucleic acid is judged as “not determined” when length of the vector is shorter than a vector length judgment criterion.

10. The method of claim 5, wherein the angle judgment criteria are defined by mean values and standard deviations of a plurality of measured data of sample nucleic acids having known nucleotide sequences.

11. An apparatus for determining nucleotide sequence in a sample nucleic acid solution comprising:
a chip cartridge having a plurality of first detecting electrodes to which first probe nucleic acids are respectively immobilized, a plurality of second detecting electrodes to which second probe nucleic acids having different nucleotide sequences from the first probe nucleic acids are respectively immobilized, and a plurality of control electrodes to which control nucleic acids having different nucleotide sequences from the first and second probe nucleic acids are respectively immobilized;
a detecting system configured to detect first detection signals through the first detecting electrodes, second detection signals through the second detecting electrodes, and control signals through the control electrodes, respectively;
a fluid transport system configured to inject a reagent solution into the chip cartridge; and
a computer comprising a typing module configured to calculate a value of a first difference obtained by subtracting a mean value of the control signals from a mean value of the first detection signals, and to divide the value of the first difference by the mean value of the control signals so as to define a value of X-coordinate, to calculate a value of a second difference obtained by subtracting the mean value of the control signals from a mean value of the second detection signals, and dividing the value of the second difference by the mean value of the control signals so as to define a value of Y-coordinate, to calculate an angle between a positive X-axis and a vector from origin to a point which is defined by the X-coordinate and the Y-coordinate, and to compare the angle with angle judgment criteria so as to identify a genotype of the sample nucleic acid.

12. The system of claim 11, wherein the computer further comprises a current-profile judgement module configured to receive the first detection signals, the second detection signals and the control signals as current-voltage characteristic curves through the detecting system, to obtain slopes of tail lines in each of the current-voltage characteristic curves, to assign normality or abnormality of the current-voltage characteristics curve from the slopes of the tail lines, and to exclude abnormal detection signals from calculation object.

13. The system of claim 12, wherein the computer further comprises a net current calculation module configured to subtract a corresponding baseline current value defined in the current-voltage characteristic curves established by the first detection signals, the second detection signals, and the control signals from corresponding peak currents in the current-voltage characteristic curves established by the first detection signals, the second detection signals, and the control signals, respectively, so as to obtain net currents for the first detection signals, the second detection signals, and the control signals.

14. The system of claim 13, wherein the computer further comprises a normality-of-group judgement module configured to determine a normal data group and an abnormal data group, from a plurality of data groups consisting of the net currents obtained by the net current calculation module, so as to eliminate the abnormal data group.

15. The system of claim 14, wherein the computer further comprises a presence judgement module configured to judge whether a target sequence is present in the sample nucleic acid solution using the normal data group of net currents.

16. A computer program product to be executed by an apparatus for determining nucleotide sequence, the computer program product comprising:
instructions configured to inject a reagent solution into a chip cartridge, which is provided with a plurality of first detecting electrodes to which first probe nucleic acids are respectively immobilized, a plurality of second detecting electrodes to which second probe nucleic acids having different nucleotide sequences from the first probe nucleic acids are respectively immobilized, and a plurality of control electrodes to which control nucleic acids having different nucleotide sequences from the first and second probe nucleic acids are respectively immobilized;
instructions configured to detect first detection signals through the first detecting electrodes, second detection signals through the second detecting electrodes, and control signals through the control electrodes, respectively;
instructions configured to calculate a value of a first difference obtained by subtracting a mean value of the control signals from a mean value of the first detection signals, and to divide the value of the first difference by the mean value of the control signals so as to define a value of X-coordinate;
instructions configured to calculate a value of a second difference obtained by subtracting a mean value of the control signals from a mean value of the second detection signals, and to divide the value of the second difference by the mean value of the control signals so as to define a value of Y-coordinate;
instructions configured to calculate an angle between a positive X-axis and a vector from origin to a point which is defined by the X-coordinate and the Y-coordinate; and
instructions configured to compare the angle with angle judgment criteria so as to identify a genotype of the sample nucleic acid.
